(19) United States
(12) Patent Application Publication
(10) Pub. No.: US 2026/0167497 A1
(43) Pub. Date: Jun. 18, 2026

(54) Graphene Foam Particles, Devices Containing Same, and Production Process

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 18/983,190

(22) Filed: Dec. 16, 2024

(51) Int. Cl. C01B 32/194; C01B 32/192; C01B 32/198; C01B 32/22

(52) U.S. Cl. CPC C01B 32/194; C01B 32/192; C01B 32/198; C01B 32/22; C01B 2204/02; C01B 2204/32; C01P 2002/78; C01P 2004/61; C01P 2004/62; C01P 2004/64; C01P 2006/10; C01P 2006/12; C01P 2006/16

(57) ABSTRACT

A solid mass of multiple graphene foam particles wherein at least a particle has a particle size in the range of 10 nm to 10 cm and comprises multiple pores and multiple graphene sheets the form pore walls and the graphene sheets contain a pristine graphene material, having essentially zero % of non-carbon elements, or a non-pristine graphene material having 0.001% to 55% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, chemically functionalized graphene, or a combination thereof.

### FIELD

The present invention relates generally to the field of graphene foams and, more particularly, to a new form of porous graphene material herein referred to as graphene foam particles, devices containing these porous graphene particles, and a process for producing same.

### BACKGROUND

Carbon is known to have five unique crystalline structures, including diamond, fullerene (0-D nano graphitic material), carbon nano-tube or carbon nano-fiber (1-D nano graphitic material), graphene (2-D nano graphitic material), and graphite (3-D graphitic material). The carbon nano-tube (CNT) refers to a tubular structure grown with a single wall or multi-wall.

Carbon nano-tubes (CNTs) and carbon nano-fibers (CNFs) have a diameter on the order of a few nanometers to a few hundred nanometers. Their longitudinal, hollow structures impart unique mechanical, electrical and chemical properties to the material. The CNT or CNF is a one-dimensional nano carbon or 1-D nano graphite material.

Bulk natural graphite is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). Although all the graphene planes in one grain are parallel to one another, typically the graphene planes in one grain and the graphene planes in an adjacent grain are inclined at different orientations. In other words, the orientations of the various grains in a graphite particle typically differ from one grain to another.

The constituent graphene planes of a graphite crystallite in a natural or artificial graphite particle can be exfoliated and extracted or isolated to obtain individual graphene sheets of carbon atoms provided the inter-planar van der Waals forces can be overcome. An isolated, individual graphene sheet of carbon atoms is commonly referred to as single-layer graphene. A stack of multiple graphene planes bonded through van der Waals forces in the thickness direction with an inter-graphene plane spacing of approximately 0.3354 nm is commonly referred to as a multi-layer graphene. A multi-layer graphene platelet has up to 300 layers of graphene planes (<100 nm in thickness), but more typically up to 30 graphene planes (<10 nm in thickness), even more typically up to 20 graphene planes (<7 nm in thickness), and most typically up to 10 graphene planes (commonly referred to as few-layer graphene in scientific community). Single-layer graphene and multi-layer graphene sheets are collectively called “nano graphene platelets” (NGPs). Graphene or graphene oxide sheets/platelets (collectively, NGPs) are a new class of carbon nano material (a 2-D nano carbon) that is distinct from the 0-D fullerene, the 1-D CNT, and the 3-D graphite.

Our research group pioneered the development of graphene materials and related production processes as early as 2002: (1) B. Z. Jang and W. C. Huang, “Nano-scaled Graphene Plates,” U.S. Pat. No. 7,071,258(Jul. 7, 2006 ), application submitted on Oct. 21, 2002; (2) B. Z. Jang, et al. “Process for Producing Nano-scaled Graphene Plates,” U.S. patent application Ser. No. 10/858,814(Jun. 3, 2004 ); and (3) B. Z. Jang, A. Zhamu, and J. Guo, “Process for Producing Nano-scaled Platelets and Nanocomposites,” US Pat. Application No. Ser. No. 11/509,424 (Aug. 25, 2006). In one process, graphene materials are obtained by intercalating natural graphite particles with a strong acid and/or an oxidizing agent to obtain a graphite intercalation compound (GIC) or graphite oxide (GO), as illustrated in FIG. 1A (process flow chart) and FIG. 1B (schematic drawing). The presence of chemical species or functional groups in the interstitial spaces between graphene planes serves to increase the inter-graphene spacing (d₀₀₂, as determined by X-ray diffraction), thereby significantly reducing the van der Waals forces that otherwise hold graphene planes together along the c-axis direction. The GIC or GO is most often produced by immersing natural graphite powder (20 in FIGS. 1A and 100 in FIG. 1B) in a mixture of sulfuric acid, nitric acid (an oxidizing agent), and another oxidizing agent (e.g. potassium permanganate or sodium perchlorate). The resulting GIC (22 or 102) is actually some type of graphite oxide (GO) particles if an oxidizing agent is present during the intercalation procedure. This GIC or GO is then repeatedly washed and rinsed in water to remove excess acids, resulting in a graphite oxide suspension or dispersion, which contains discrete and visually discernible graphite oxide particles dispersed in water. In order to produce graphene materials, one can follow one of the two processing routes after this rinsing step, briefly described below:

Route 1 involves removing water from the suspension to obtain “expandable graphite,” which is essentially a mass of dried GIC or dried graphite oxide particles. Upon exposure of expandable graphite to a temperature in the range of typically 800-1,050° C. for approximately 30 seconds to 2 minutes, the GIC undergoes a rapid volume expansion by a factor of 30-300 to form “graphite worms” (24 or 104), which are each a collection of exfoliated, but largely un-separated graphite flakes that remain interconnected. A SEM image of graphite worms is presented in FIG. 2.

In Route 1A, these graphite worms (exfoliated graphite or “networks of interconnected/non-separated graphite flakes”) can be re-compressed to obtain flexible graphite sheets or foils (26 or 106) that typically have a thickness in the range of 0.1 mm (100 μm)-0.5 mm (500 μm). Alternatively, one may choose to use a low-intensity air mill or shearing machine to simply break up the graphite worms for the purpose of producing the so-called “expanded graphite flakes” (49 or 108) which contain mostly graphite flakes or platelets thicker than 100 nm (hence, not a nano material by definition).

In Route 1B, the exfoliated graphite is subjected to high-intensity mechanical shearing (e.g. using an ultrasonicator, high-shear mixer, high-intensity air jet mill, or high-energy ball mill) to form separated single-layer and multi-layer graphene sheets (collectively called NGPs, 33 or 112), as disclosed in our U.S. application Ser. No. 10/858,814. Single-layer graphene can be as thin as 0.34 nm, while multi-layer graphene can have a thickness up to 100 nm, but more typically less than 10 nm (commonly referred to as few-layer graphene). Multiple graphene sheets or platelets may be made into a sheet of NGP paper (34) using a paper-making process.

Route 2 entails ultrasonicating the graphite oxide suspension for the purpose of separating/isolating individual graphene oxide sheets from graphite oxide particles. This is based on the notion that the inter-graphene plane separation bas been increased from 0.3354 nm in natural graphite to 0.6-1.1 nm in highly oxidized graphite oxide, significantly weakening the van der Waals forces that hold neighboring planes together. Ultrasonic power can be sufficient to further separate graphene plane sheets to form separated, isolated, or discrete graphene oxide (GO) sheets. These graphene oxide sheets can then be chemically or thermally reduced to obtain “reduced graphene oxides” (RGO) typically having an oxygen content of 0.001%-10% by weight, more typically 0.01%-5% by weight, most typically and preferably less than 2% by weight.

For the purpose of defining the claims of the instant application, graphene materials include discrete sheets/platelets of single-layer and multi-layer (typically less than 10 layers) pristine graphene, graphene oxide, reduced graphene oxide (RGO), graphene fluoride, graphene chloride, graphene bromide, graphene iodide, hydrogenated graphene, nitrogenated graphene, chemically functionalized graphene, and doped graphene (e.g. doped by B or N). Pristine graphene has essentially 0% oxygen (or less than 0.001% by weight of oxygen). RGO typically has an oxygen content of 0.001%-5% by weight. Graphene oxide (including RGO) can have 0.001%-57% by weight of oxygen. Other than pristine graphene, all the graphene materials have 0.001%-57% by weight of non-carbon elements (e.g. O, H, N, B, F, Cl, Br, I, etc.). These materials are herein referred to as non-pristine graphene materials.

Another process for producing graphene, in a thin film form (typically <2 nm in thickness), is the catalytic chemical vapor deposition process. This catalytic CVD involves catalytic decomposition of hydrocarbon gas (e.g. C₂H₄) on Ni or Cu surface to form single-layer or few-layer graphene. With Ni or Cu being the catalyst, carbon atoms obtained via decomposition of hydrocarbon gas molecules at a temperature of 800-1,000° C. are directly deposited onto Cu foil surface or precipitated out to the surface of a Ni foil from a Ni—C solid solution state to form a sheet of single-layer or few-layer graphene (less than 5 layers). The Ni- or Cu-catalyzed CVD process does not lend itself to the deposition of more than 5 graphene planes (typically <2 nm) beyond which the underlying Ni or Cu layer can no longer provide any catalytic effect. The CVD graphene films are extremely expensive.

Generally speaking, a foam or foamed material is composed of pores (or cells) and pore walls (a solid material). The pores can be interconnected to form an open-cell foam. A graphene foam is composed of pores and pore walls that contain a graphene material. There are three major methods of producing graphene foams:

The first method is the hydrothermal reduction of graphene oxide hydrogel that typically involves sealing graphene oxide (GO) aqueous suspension in a high-pressure autoclave and heating the GO suspension under a high pressure (tens or hundreds of atm) at a temperature typically in the range of 180-300° C. for an extended period of time (typically 12-36 hours). A. useful reference for this method is given here: Y. Xu, et al. “Self-Assembled Graphene Hydrogel via a One-Step Hydrothermal Process,” ACS Nano 2010, 4, 4324-4330. There are several major issues associated with this method: (a) The high pressure requirement makes it an impractical method for industrial-scale production. For one thing, this process cannot be conducted on a continuous basis. (b) It is difficult, if not impossible, to exercise control over the pore size and the porosity level of the resulting porous structure. (c) There is no flexibility in terms of varying the shape and size of the resulting reduced graphene oxide (RGO) material (e.g. it cannot be made into a film shape). (d) The method involves the use of an ultra-low concentration of GO suspended in water (e.g. 2 mg/mL=2 g/L=2 kg/kL). With the removal of non-carbon elements (up to 50%), one can only produce less than 2 kg of graphene material (RGO) per 1000-liter suspension. Furthermore, it is practically impossible to operate a 1000-liter reactor that has to withstand the conditions of a high temperature and a high pressure. Clearly, this is not a scalable process for mass production of porous graphene structures.

The second method is based on a template-assisted catalytic CVD process, which involves CVD deposition of graphene on a sacrificial template (e.g. Ni foam). The graphene material conforms to the shape and dimensions of the Ni foam structure. The Ni foam is then etched away using an etching agent, leaving behind a monolith of graphene skeleton that is essentially an open-cell foam. A useful reference for this method is given here: Zongping Chen, et al., “Three-dimensional flexible and conductive interconnected graphene networks grown by chemical vapour deposition,” Nature Materials, 10 (June 2011) 424-428. There are several problems associated with such a process: (a) the catalytic CVD is intrinsically a very slow, highly energy-intensive, and expensive process; (b) the etching agent is typically a highly undesirable chemical and the resulting Ni-containing etching solution is a source of pollution. It is very difficult and expensive to recover or recycle the dissolved Ni metal from the etchant solution. (c) It is challenging to maintain the shape and dimensions of the graphene foam without damaging the cell walls when the Ni foam is being etched away. The resulting graphene foam is typically very brittle and fragile. (d) The transport of the CVD precursor gas (e.g. hydrocarbon) into the interior of a metal foam can be difficult, resulting in a non-uniform structure, since certain spots inside the sacrificial metal foam may not be accessible to the CVD precursor gas.

The third method of producing graphene foam also makes use of a sacrificial material (e.g. colloidal polystyrene particles, PS) that is coated with graphene oxide sheets using a self-assembly approach. For instance, Choi, et al. prepared chemically modified graphene (CMG) paper in two steps: fabrication of free-standing PS/CMG films by vacuum filtration of a mixed aqueous colloidal suspension of CMG and PS (2.0 μm PS spheres), followed by removal of PS beads to generate 3D macro-pores. [B. G. Choi, et al., “3D Macroporous Graphene Frameworks for Supercapacitors with High Energy and Power Densities,” ACS Nano, 6 (2012) 4020-4028.] Choi, et al. fabricated well-ordered free-standing PS/CMG paper by filtration, which began with separately preparing a negatively charged CMG colloidal and a positively charged PS suspension. A mixture of CMG colloidal and PS suspension was dispersed in solution under controlled pH (=2), where the two compounds had the same surface charges (zeta potential values of +13±2.4 m V for CMG and +68±5.6 mV for PS). When the pH was raised to 6, CMGs (zeta potential =−29±3.7 m V) and PS spheres (zeta potential =+51±2.5 mV) were assembled due to the electrostatic interactions and hydrophobic characteristics between them, and these were subsequently integrated into PS/CMG composite paper through a filtering process. This method also has several shortcomings: (a) This method requires very tedious chemical treatments of both graphene oxide and PS particles. (b) The removal of PS by toluene also leads to weakened macro-porous structures. (c) Toluene is a highly regulated chemical and should be treated with extreme caution. (d) The pore sizes are typically excessively big (e.g. several um), too big for many useful applications.

The above discussion clearly indicates that every prior art method or process for producing graphene foams has major deficiencies. There does not appear to have prior art methods capable of cost-effectively producing graphene foam particles (not in a bulk or sheet/film form). Thus, it is an object of the present invention to provide a cost-effective process for producing mechanically robust graphene foam particles in large quantities. These graphene foam particles can range from highly conducting (e.g., pristine graphene) to insulating (e.g., heavily oxidized graphene). They can be formed in wide ranges of particle sizes and pore sizes. This process does not involve the use of an environmentally unfriendly chemical. This process enables the flexible design and control of the porosity level and pore sizes.

Yet another object of the present invention is to provide (a) pristine graphene foam particles that contain essentially all carbon only and preferably have a meso-scaled pore size range (2-50 nm); (b) non-pristine graphene foam particles (porous particles of graphene fluoride, graphene chloride, nitrogenated graphene, etc.) that contains at least 0.001% by weight (typically from 0.01% to 57% by weight and more typically from 0.01% to 20%) of non-carbon elements, and (c) devices that comprise these graphene foam particles as a functional element.

### SUMMARY

The present invention provides a solid mass of multiple individual graphene foam particles (porous graphene particles) wherein at least a particle has a particle size from 10 nm to 5 cm (preferably from 100 nm to 1 mm and further preferably from 1 μm to 100 μm) and comprises multiple pores and multiple graphene sheets that are self-bonded or bonded by a binder (e.g., an adhesive resin, a carbonaceous material, metal, or other organic or inorganic material) to form the pore walls, and wherein the graphene sheets contain a pristine graphene material, having essentially zero % (less than 0.01% by weight) of non-carbon elements, or a non-pristine graphene material having 0.01% to 57% by weight of non-carbon elements wherein the non-pristine graphene is selected from graphene oxide, reduced graphene oxide, graphene fluoride, graphene chloride, graphene bromide, graphene iodide, hydrogenated graphene, nitrogenated graphene, chemically functionalized graphene, or a combination thereof.

In certain embodiments, the solid graphene foam particle has a density from 0.001 to 1.7 g/cm³ and a specific surface area from 50 to 3,000 m²/g, and the pores have an average pore size in a range from 1 nm to 1 mm (preferably and more typically from 2 nm to 0.1 mm). In some preferred embodiments, pore walls contain a pristine graphene and the solid graphene foam particle has a density from 0.5 to 1.7 g/cm³ or an average pore size from 1 nm to 50 nm.

In certain embodiments, the pore walls contain stacked graphene planes having an inter-plane spacing d₀₀₂ from 0.3354 nm to 2.0 nm (preferably less than 1.0 nm and further preferably less than 0.5 nm) as measured by X-ray diffraction.

In the solid mass of multiple graphene foam particles, the non-carbon elements typically include an element selected from oxygen, fluorine, chlorine, bromine, iodine, nitrogen, hydrogen, or boron.

The pore walls in the solid mass of multiple graphene foam particles may contain a non-pristine graphene material selected from the group consisting of graphene oxide, reduced graphene oxide, graphene fluoride, graphene chloride, graphene bromide, graphene iodide, hydrogenated graphene, nitrogenated graphene, chemically functionalized graphene, and combinations thereof, and wherein the solid graphene foam particle contains a content of non-carbon elements in the range of 0.01% to 25% by weight.

In some embodiments, the graphene oxide has an oxygen content greater than 25% by weight. In certain other embodiments, the pore walls contain graphene fluoride and the solid graphene foam particle contains a fluorine content from 0.01% to 25% by weight.

In certain embodiments, the graphene foam has a specific surface area from 200 to 2,000 m²/g or a density from 0.1 to 1.5g/cm³.

In the solid mass of multiple graphene foam particles, the particles preferably have an average size from 20 nm to 2 mm, further preferably from 50 nm to 0.5 mm. The graphene foam particles may be in a form or shape selected from a spherical particle, ellipsoidal particle, elongated particle, fiber, disc, platelet, tube, rod, any regular or irregular shape or odd shape.

In certain embodiments, the graphene foam particle has an oxygen content or non-carbon content less than 10% by weight, and the pore walls have an inter-graphene spacing less than 0.4 nm. In some embodiments, the graphene foam particle has an oxygen content or non-carbon content less than 1% by weight, and the pore walls have an inter-graphene spacing less than 0.36 nm.

In the solid mass of multiple graphene foam particles, the pore walls may contain a 3D network of interconnected graphene planes. For certain applications of graphene foam particles, the pores have a pore size from 50 nm to 100 μm.

In certain embodiments, the solid graphene foam particle contains meso-scaled pores having a pore size from 2 nm to 50 nm.

In certain embodiments of the present disclosure, the graphene foam particle further comprises a binder material that bonds multiple graphene sheets together. The binder material may be selected from a polymer, metal, glass, ceramic, carbon (e.g., amorphous carbon, polymeric carbon or carbon derived from a polymer), or a combination thereof.

In certain preferred embodiments, the multiple graphene foam particles contain chemically functionalized graphene that comprises a functional group selected from hydroxyl, peroxide, ether, ester, ketone, aldehyde, halide, alcohol, thiol, ether, sulfide, carbonyl, carboxylic, alkene, alkyne, amine, quinone, epoxy, phenolic, amino, or a combination thereof.

The pore walls may contain chemically functionalized graphene that contains a functional group selected from the group consisting of SO₃H, COOH, NH₂, NH₃, NH₄, OH, R′CHOH, CHO, CN, COCl, halide, COSH, SH, COOR′, SR′, SiR′₃, Si(—OR′—)_{y}R′₃-y, Si(—O—-SiR′₂—)OR′, R″, Li, AlR′₂, Hg—X, TIZ₂ and Mg—X, wherein y is an integer equal to or less than 3, R″ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

The solid pore walls may contain chemically functionalized graphene containing a functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof.

The pore walls may contain chemically functionalized graphene containing a functional group selected from OY, NHY, O═C—OY, P═C—NR′Y, O═C—SY, O═C—Y, —CR′l—OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

The present disclosure also provides an array of devices that contain one or a plurality of the disclosed graphene foam particles as a functional element.

For instance, the disclosure provides a thermal management device comprising the disclosed graphene foam particles as a heat-conducting, heat-spreading, heat-absorbing, heat-storing, or heat dissipating agent.

The thermal management device may contain a device selected from a heat exchanger, heat sink, heat pipe, vapor chamber, high-conductivity insert, conductive plate between a heat sink and a heat source, heat-spreading component, heat-dissipating component, thermal interface medium, or thermoelectric or Peltier cooling device.

The disclosed device may be an electromagnetic wave-or high energy radiation-absorbing device comprising the multiple graphene foam particles as an electromagnetic wave or high energy radiation-absorbing agent. The electromagnetic wave, as examples, may contain an wavelength in the visible range, ultraviolet (UV) range, microwave range, etc. The high energy radiation may contain, as examples, gamma ray, X-ray, electron beam, or ion beam, etc.

The disclosed device may be an acoustic wave or vibration-absorbing device comprising the mass of multiple graphene foam particles as an acoustic wave-absorbing agent or vibration-damping agent.

The disclosure also provides a filtration or separation device comprising a filtration, separation, or absorbing member that comprises the disclosed multiple graphene foam particles. For instance, the device may be an oil-removing or oil-separating device comprising the multiple graphene foam particles as an oil-absorbing agent. The filtration or separation device may be a solvent-removing or solvent-separating device comprising said mass of multiple graphene foam particles as a solvent-absorbing agent. The filtration or separation device may be a contaminant-removing or contaminant-separating device containing the disclosed graphene foam particles as a contaminant-absorbing agent. The filtration or separation device may be an air filter or a water purifier. In the water purification, for instance, the disclosed device is capable of capturing and separating contaminants, such as pharmaceutical chemicals, anionic and cationic dyes, heavy metals, pharmaceutical chemicals, and per-and polyfluoroalkyl substances (PFAS).

The disclosure further provides a method to separate oil from water, the method comprising the steps of: a) providing an oil-absorbing member comprising the disclosed mass of multiple graphene foam; b) contacting an oil-water mixture with said member, which absorbs the oil from the mixture; and c) retreating the member from the mixture and extracting the oil from the member. The method further comprises a step of reusing the member.

The disclosure also provides a method to separate an organic solvent from a solvent-water mixture or from a multiple-solvent mixture, the method comprising the steps of: a) providing an organic solvent-absorbing or solvent-separating member comprising the disclosed graphene foam particles; b) bringing said member in contact with an organic solvent-water mixture or a multiple-solvent mixture containing a first solvent and at least a second solvent; c) allowing the member to absorb the organic solvent from the mixture or separate the first solvent from the at least second solvent; and d) retreating the member from the mixture and extracting the organic solvent or first solvent from the member. The method may further comprise a step of reusing the member.

The presently invented solid graphene foam particles may be produced by a process comprising: (a) preparing a graphene dispersion having multiple sheets of a starting graphene material dispersed in a liquid medium, wherein said starting graphene material is selected from a pristine graphene, having a content of non-carbon elements no greater than 0.01%, or a non-pristine graphene material, having a content of non-carbon elements greater than 0.01% by weight, selected from graphene oxide, reduced graphene oxide, graphene fluoride, graphene chloride, graphene bromide, graphene iodide, hydrogenated graphene, nitrogenated graphene, chemically functionalized graphene, or a combination thereof and wherein said dispersion comprises an optional polymer having a polymer-to-graphene material weight ratio from 0/1.0 to 20/1.0 and/or an optional blowing agent having a blowing agent-to-graphene material weight ratio from 0/1.0 to 1.0/1.0; (b) forming and drying said graphene dispersion into multiple graphene foam particles; and (c) heat treating the multiple graphene foam particles at a first heat treatment temperature from 30° C. to 3,200° C. at a desired heating rate sufficient to induce volatile gas molecules from the non-carbon elements (e.g. O, H, N, B, F, Cl, Br, I, etc.) or to activate the blowing agent for producing said solid mass of graphene foam particles. The resulting solid graphene foam particles typically have a density from 0.001 to 1.7 g/cm³ (more typically from 0.01 to 1.5g/cm³, and even more typically from 0.1 to 1.0g/cm³, and most typically from 0.2 to 0.75g/cm³), or a specific surface area from 50 to 3,000m²/g (more typically from 200 to 2,000 m²/g, and most typically from 500 to 1,500 m²/g).

This optional blowing agent is not required if the graphene material has a content of non-carbon elements (e.g. O, H, N, B, F, Cl, Br, I, etc.) no less than 5% by weight (preferably no less than 10%, further preferably no less than 20%, even more preferably no less than 30% or 40%, and most preferably up to 57%). The subsequent high temperature treatment serves to remove a majority of these non-carbon elements from the graphene material, generating volatile gas species that produce pores or cells in the solid graphene material structure. In other words, quite surprisingly, these non-carbon elements play the role of a blowing agent. Hence, an externally added blowing agent is optional (not required). However, the use of a blowing agent can provide added flexibility in regulating or adjusting the porosity level and pore sizes for a desired application. The blowing agent is typically required if the non-carbon element content is less than 5%, such as pristine graphene that is essentially all-carbon, The blowing agent can be a physical blowing agent, a chemical blowing agent, a mixture thereof, a dissolution-and-leaching agent, or a mechanically introduced blowing agent.

The process may further include a step of heat-treating the solid graphene foam particles at a second heat treatment temperature higher than the first heat treatment temperature for a length of time sufficient for obtaining a solid mass of multiple individual graphene foam particles wherein the pore walls contain stacked graphene planes having an inter-plane spacing d₀₀₂ from 0.3354 nm to 2.0 nm (more typically less than 1.0 nm and further more typically less than 0.5 nm) and a content of non-carbon elements less than 5% by weight (typically from 0.001% to 2%). When the resulting non-carbon element content is from 0.1% to 2.0%, the inter-plane spacing d₀₀₂ is typically from 0.337 nm to 0.40 nm.

If the original graphene material in the dispersion contains a non-carbon element content higher than 5% by weight, the graphene material in the solid graphene foam (after the heat treatment) contains structural defects that are induced during the step of heat treating. The liquid medium can be simply water and/or an alcohol, which is environmentally benign.

In one embodiment, the first heat treatment temperature is from 100° C. to 1,500° C. In another embodiment, the second heat treatment temperature includes at least a temperature selected from (A) 300-1,500° C., (B) 1,500-2,100° C., and/or (C) 2,100-3,200° C. In a specific embodiment, the second heat treatment temperature includes a temperature in the range of 300-1,500° C. for at least 1 hour and then a temperature in the range of 1,500-3,200° C. for at least 1 hour.

There are several surprising results of conducting first and/or second heat treatments to the dried multiple graphene foam particles, and different heat treatment temperature ranges enable us to achieve different purposes, such as (a) removal of non-carbon elements from the graphene material (e.g. thermal reduction of fluorinated graphene to obtain graphene or reduced graphene fluoride, RGF)) which generate volatile gases to produce pores or cells in a graphene material, (b) activation of the chemical or physical blowing agent to produce pores or cells, (c) chemical merging or linking of graphene sheets to significantly increase the lateral dimension of graphene sheets in the pore walls (solid portion of the pores), (d) healing of defects created during fluorination, oxidation, or nitrogenation of graphene planes in a graphite particle, and (e) re-organization and perfection of graphitic domains or graphite crystals. These different purposes or functions are achieved to different extents within different temperature ranges. The non-carbon elements typically include an element selected from oxygen, fluorine, chlorine, bromine, iodine, nitrogen, hydrogen, or boron. Quite surprisingly, even under low-temperature foaming conditions, heat-treating induces chemical linking, merging, or chemical bonding between graphene sheets, often in an edge-to-edge manner (some in face-to-face manner).

In one embodiment, the solid graphene foam particles have a specific surface area from 200 to 2,000 m²/g. In one embodiment, the graphene foam particles have a density from 0.1 to 1.5 g/cm³.

In an embodiment, the graphene dispersion has at least 3% by weight of graphene oxide dispersed in the liquid medium to form a liquid crystal phase. In another embodiment, the graphene dispersion contains a graphene oxide dispersion prepared by immersing a graphitic material in a powder or fibrous form in an oxidizing liquid in a reaction vessel at a reaction temperature for a length of time sufficient to obtain the graphene dispersion wherein the graphitic material is selected from natural graphite, artificial graphite, meso-phase carbon, meso-phase pitch, meso-carbon micro-bead, soft carbon, hard carbon, coke, carbon fiber, carbon nano-fiber, carbon nano-tube, biochar, biochar derivative, or a combination thereof and wherein the graphene oxide has an oxygen content no less than 5% by weight.

In an embodiment, the first heat treatment temperature contains a temperature in the range of 80° C.-300° C. and, as a result, the graphene foam particles have an oxygen content or non-carbon element content less than 5%, and the pore walls have an inter-graphene spacing less than 0.40 nm, a thermal conductivity of at least 150 W/mK (more typically at least 200 W/mk) per unit of specific gravity, and/or an electrical conductivity no less than 2,000 S/cm per unit of specific gravity.

In a preferred embodiment, the first and/or second heat treatment temperature contains a temperature in the range of 300° C.-1,500° C. and, as a result, the graphene foam particles have an oxygen content or non-carbon content less than 1%, and the pore walls have an inter-graphene spacing less than 0.35 nm, a thermal conductivity of at least 250 W/mK per unit of specific gravity, and/or an electrical conductivity no less than 2,500 S/cm per unit of specific gravity.

When the first and/or second heat treatment temperature contains a temperature in the range of 1,500° C.-2,100° C., the graphene foam particles have an oxygen content or non-carbon content less than 0.01% and pore walls have an inter-graphene spacing less than 0.34 nm, a thermal conductivity of at least 300 W/mK per unit of specific gravity, and/or an electrical conductivity no less than 3,000 S/cm per unit of specific gravity.

When the first and/or second heat treatment temperature contains a temperature greater than 2,100° C., the graphene foam particles have an oxygen content or non-carbon content no greater than 0.001% and pore walls have an inter-graphene spacing less than 0.336 nm, a mosaic spread value no greater than 0.7, a thermal conductivity of at least 350 W/mK per unit of specific gravity, and/or an electrical conductivity no less than 3,500 S/cm per unit of specific gravity.

If the first and/or second heat treatment temperature contains a temperature no less than 2,500° C., the graphene foam particles have pore walls containing stacked graphene planes having an inter-graphene spacing less than 0.336 nm, a mosaic spread value no greater than 0.4, and a thermal conductivity greater than 400 W/mK per unit of specific gravity, and/or an electrical conductivity greater than 4,000 S/cm per unit of specific gravity.

In one embodiment, the pore walls contain stacked graphene planes having an inter-graphene spacing less than 0.337 nm and a mosaic spread value less than 1.0. In another embodiment, the solid wall portion of the graphene foam particles exhibit a degree of graphitization no less than 80% and/or a mosaic spread value less than 0.4. In yet another embodiment, the solid wall portion of the graphene foam particles exhibits a degree of graphitization no less than 90% and/or a mosaic spread value no greater than 0.4.

Typically, the pore walls contain a 3D network of interconnected graphene planes that are electron-conducting pathways. The cell walls contain graphitic domains or graphite crystals having a lateral dimension (Lₐ, length or width) no less than 20 nm, more typically and preferably no less than 40 nm, still more typically and preferably no less than 100 nm, still more typically and preferably no less than 500 nm, often greater than 1 μm, and sometimes greater than 10 μm. The graphitic domains typically have a thickness from 1 nm to 200 nm, more typically from 1 nm to 100 nm, further more typically from 1 nm to 40 nm, and most typically from 1 nm to 30 nm.

For certain applications (e.g., as a filter member), the solid graphene foam particles contain meso-scaled pores having a pore size from 2 nm to 50 nm (preferably 2 nm to 25 nm). It may be noted that it has not been possible to use Ni-catalyzed CVD to produce particles of graphene foams having a pore size range of 2-50 nm. This is due to the notion that it has not been proven possible to prepare Ni foam templates having such a pore size range and not possible for the hydrocarbon gas (precursor molecules) to readily enter Ni foam pores of these sizes. These Ni foam pores should also be interconnected. Additionally, the sacrificial plastic colloidal particle approaches have resulted in macro-pores that are in the size range of microns to millimeters.

In certain embodiments, the graphene dispersion in step (a) comprises a polymer having a polymer-to-graphene material weight ratio from 0/1.0 to 20/1.0. The polymer may simply serve as an adhesive that bonds graphene sheets together. The polymer may serve as a solid substrate that can support certain chemical functional groups that are capable of attracting, capturing, or absorbing contaminant species such as pharmaceutical chemicals, anionic and cationic dyes, heavy metals, pharmaceutical chemicals, and PFAS. Alternatively, the polymer may serve as a precursor to carbon, which can serve as a binding agent.

Thus, in certain embodiments, the multiple graphene foam particles, after step (c), are impregnated with a polymer and the impregnated polymer bonds multiple graphene sheets in a graphene foam particle together.

In some embodiments, the multiple graphene foam particles, after step (c), are impregnated with a polymer and the process further comprises a step of heating the multiple graphene foam particles at a temperature for a period of time sufficient to convert the impregnated polymer into carbon that bonds multiple graphene sheets in a graphene foam particle together.

In certain preferred embodiments, the multiple graphene foam particles, after step (c), are subjected to a functionalization treatment to attach chemical functional groups to a surface or pore walls of a graphene particle.

In the disclosed process, step (b) may comprise a procedure selected from spray-drying, spray cooling, fluidized bed particle treatment, extrusion and fiber fragmentation, pan coating, centrifuge-induced particle formation, self-assembling of graphene sheets, air-suspension coating, freeze-drying, centrifugal extrusion, vibration nozzle coating, hydrothermal encapsulation, milling, supercritical fluid coating, electro-spinning, or in-situ polymerization.

The present disclosure also provides a process for producing the disclosed solid mass of multiple individual graphene foam particles, the process comprising: (a) preparing multiple graphene sheets; (b) applying a secondary particle-forming procedure to form multiple secondary particles from the multiple graphene sheets, wherein the multiple secondary particles comprise pores therein or comprise a polymer composite having a polymer binder or polymer matrix; and (c) heat treating the multiple secondary particles at a heat treatment temperature from 30° C. to 3,200° C. for producing the solid mass of graphene foam particles.

The secondary particle-forming procedure may comprise a procedure selected from spray-drying, spray cooling, fluidized bed particle treatment, extrusion and fiber fragmentation, pan coating, centrifuge-induced particle formation, self-assembling of graphene sheets, air-suspension coating, freeze-drying, centrifugal extrusion, vibration nozzle coating, hydrothermal encapsulation, supercritical fluid coating, milling, electro-spinning, or in-situ polymerization.

### BRIEF DESCRIPTION OF THE DRAWINGS

FIG. 1A A flow chart illustrating various prior art processes of producing exfoliated graphite products (flexible graphite foils and expanded graphite flakes), along with a process for producing pristine graphene foam 40a or graphene oxide foams 40b;

FIG. 1B Schematic drawing illustrating the processes for producing conventional paper, mat, film, and membrane of simply aggregated graphite or NGP flakes/platelets. All processes begin with intercalation and/or oxidation treatment of graphitic materials (e.g. natural graphite particles).

FIG. 2 A SEM image of a graphite worm sample after thermal exfoliation of graphite intercalation compounds (GICs) or graphite oxide powders.

FIG. 3 A possible mechanism of chemical linking between graphene oxide sheets that can effectively increase the graphene sheet lateral dimensions or form a 3D graphene structure.

FIG. 4A Schematic of a graphene foam particle comprising graphene sheets assembled into a desired shape (e.g., spherical or ellipsoidal shape) that contains pores and pore walls (e.g., single-layer or few-layer graphene sheets); the graphene sheets may be self-bonded together through chemical linking or may be bonded together by a polymer, carbon, metal, glass, ceramic, or other organic or inorganic binder,

FIG. 4B Schematic of a graphene foam particle comprising graphene sheets assembled into a desired shape that contains pores and pore walls; the graphene walls being composed of graphene planes bonded by or dispersed in a polymer or carbonaceous material.

FIG. 5A Inter-graphene plane spacing in the pore walls of graphene foam particles as measured by X-ray diffraction;

FIG. SB The oxygen content in the GO suspension-derived graphene foam particles.

FIG. 6 Schematic of heat sink structures (2 examples).

FIG. 7A SEM image of secondary graphene particles after spray drying.

FIG. 7B SEM image of graphene foam particles after heat-induced pore forming.

### DETAILED DESCRIPTION

The present disclosure provides a solid mass of multiple individual graphene foam particles (porous graphene particles) wherein at least a particle has a particle size from 10 nm to 10 cm (preferably from 100 nm to 1 mm and further preferably from 1 μm to 100 μm) and comprises multiple pores and multiple graphene sheets that are self-bonded or bonded by a binder (e.g., an adhesive resin, a carbonaceous material, metal, other organic or inorganic material) to form the pore walls, and wherein the graphene sheets contain a pristine graphene material, having essentially zero % (less than 0.01% by weight) of non-carbon elements, or a non-pristine graphene material having 0.01% to 57% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, chemically functionalized graphene, or a combination thereof.

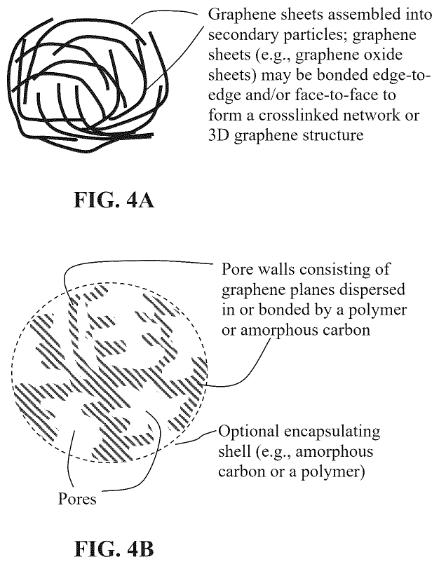

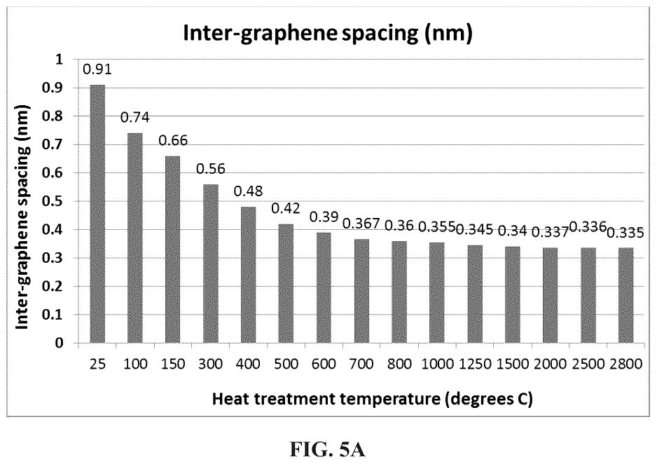

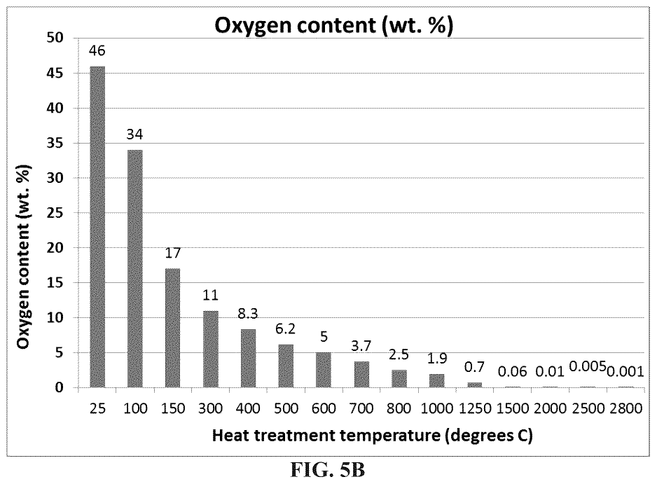

As schematically illustrated in FIG. 4A, self-bonded graphene sheets in the pore walls refer to the graphene sheets that are (1) chemically linked/merged together (edge-to-edge and/or face-to-face) typically at a temperature from 100 to 1,500° C. and/or (2) re-organized into larger graphite crystals or domains (herein referred to as re-graphitization) along the pore walls at a high temperature (typically >2,100° C. and more typically >2,500 C.) during the presently disclosed heat treatment procedure.

FIG. 4B schematically shows a graphene foam particle comprising graphene sheets assembled into a desired shape that contains pores and pore walls, wherein the graphene walls are composed of graphene planes bonded by a binder or dispersed in a matrix (e.g., a polymer or carbonaceous material).

In certain embodiments, the solid graphene foam particle has a density from 0.001 to 1.7 g/cm³ and a specific surface area from 50 to 3,000m²/g, and the pores have an average pore size in a range from 1 nm to 1 mm. In some preferred embodiments, pore walls contain a pristine graphene and said solid graphene foam has a density from 0.5 to 1.7 g/cm³ or an average pore size from 1 nm to 50 nm.

In certain embodiments, the pore walls contain stacked graphene planes having an inter-plane spacing d₀₀₂ from 0.3354 nm to 2.0 nm (preferably less than 1.0 nm and further preferably less than 0.5 nm) as measured by X-ray diffraction.

In the solid mass of multiple graphene foam particles, the non-carbon elements include an element selected from oxygen, fluorine, chlorine, bromine, iodine, nitrogen, hydrogen, or boron. The pore walls in the solid mass of multiple graphene foam particles may contain a non-pristine graphene material selected from the group consisting of graphene oxide, reduced graphene oxide, graphene fluoride, graphene chloride, graphene bromide, graphene iodide, hydrogenated graphene, nitrogenated graphene, chemically functionalized graphene, and combinations thereof, and wherein the solid graphene foam particle contains a content of non-carbon elements in the range of 0.01% to 25% by weight.

In some embodiments, the graphene oxide has an oxygen content greater than 25% by weight. In certain other embodiments, the pore walls contain graphene fluoride and the solid graphene foam particle contains a fluorine content from 0.01% to 25% by weight.

In certain embodiments, the graphene foam has a specific surface area from 200 to 2,630 m²/g or a density from 0.1 to 1.5g/cm³.

In the solid mass of multiple graphene foam particles, the particles preferably have an average size from 20 nm to 2 mm, further preferably from 50 nm to 0.5 mm, and more preferably from 100 nm to 100 μm, depending upon a specific application. The graphene foam particles may be in a form or shape selected from a spherical particle, ellipsoidal particle, elongated particle, fiber, disc, plate, tube, rod, or odd shape (any regular or irregular shape).

In certain embodiments, the graphene foam particle has an oxygen content or non-carbon content less than 10% by weight, and the pore walls have an inter-graphene spacing less than 0.4 nm. In some embodiments, the graphene foam particle has an oxygen content or non-carbon content less than 1% by weight, and the pore walls have an inter-graphene spacing less than 0.36 nm.

In the solid mass of multiple graphene foam particles, the pore walls may contain a 3D network of interconnected graphene planes. For certain applications of graphene foam particles, the pores have a pore size from 50 nm to 100 μm.

In certain embodiments, the solid graphene foam particle contains meso-scaled pores having a pore size from 2 nm to 50 nm.

In certain embodiments of the present disclosure, the graphene foam particle further comprises a binder material that bonds multiple graphene sheets together. The binder material may be selected from a polymer, metal, glass, ceramic, carbon (e.g., amorphous carbon, polymeric carbon or carbon derived from a polymer), or a combination thereof.

In certain preferred embodiments, the multiple graphene foam particles contain chemically functionalized graphene that comprises a functional group selected from hydroxyl, peroxide, ether, ester, ketone, aldehyde, halide, alcohol, thiol, ether, sulfide, carbonyl, carboxylic, alkene, alkyne, amine, quinone, epoxy, phenolic, amino, or a combination thereof.

The pore walls may contain chemically functionalized graphene that contains a functional group selected from the group consisting of SO₃H, COOH, NH₂, NH₃, NH₄, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X, wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

The solid pore walls may contain chemically functionalized graphene containing a functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof.

The pore walls may contain chemically functionalized graphene containing a functional group selected from OY, NHY, O═C—OY, P═C—NR′Y, O═C—SY, O═C—Y, —CR′l—OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

The present disclosure also provides several devices that each contains one or a plurality of the disclosed graphene foam particles.

For instance, the disclosure provides a thermal management device comprising the disclosed graphene foam particles as a heat-conducting, heat spreading, heat-absorbing, heat-storing, or heat dissipating agent.

The thermal management device may contain a device selected from a heat exchanger, heat sink, heat pipe, vapor chamber, high-conductivity insert, conductive plate between a heat sink and a heat source, heat-spreading component, heat-dissipating component, thermal interface medium, or thermoelectric or Peltier cooling device.

The disclosed device may be a filtration device (e.g., in a water or air filtration system), separation device (e.g., separation of oil from water), or purification device (e.g., for removing contaminants from water).

The disclosed device may be an acoustic wave or vibration-absorbing device comprising the mass of multiple graphene foam particles as an acoustic wave-absorbing agent or vibration-damping agent.

The disclosed device may be an electromagnetic wave-or high energy radiation-absorbing device comprising the multiple graphene foam particles as an electromagnetic wave or high energy radiation-absorbing agent. The electromagnetic wave, as examples, may contain an wavelength in the visible range, ultraviolet (UV) range, microwave range, etc. The high energy radiation may contain, as examples, gamma ray, X-ray, electron beam, or ion beam, etc.

### Thermal Management Applications

The aforementioned features and characteristics make the graphene foam particles an ideal element for a broad array of engineering and biomedical applications. For instance, for thermal management purposes alone, the graphene foam particles can be used in the following forms for various applications:
a) The graphene foam particles may be compacted together (with or without a binder resin) to become a compressible and elastic member (or element) of high thermal conductivity, which is ideally suited for use as a thermal interface material (TIM) that can be implemented between a heat source and a heat spreader or between a heat source and a heat sink.
b) The graphene foam particles can be filled into odd-shaped spaces as a heat spreader per se due to its high thermal conductivity.
c) The light weight (low density adjustable between 0.001 and 1.7g/cm³), high thermal conductivity per unit specific gravity or per unit of physical density, and high structural integrity (graphene sheets being bonded by carbon) make the graphene balls (coupling with a binder or matrix material) an ideal material for a durable heat exchanger. The matrix or binder material can be a polymer, a metal (e.g. Cu and Al), a pitch (e.g. petroleum pitch, coal tar pitch, meso-phase pitch, etc.), glass, or ceramic (e.g. boron nitride).
d) The graphene foam particles can be a thermally conductive additive of a conductive coating or paint formulation. The high thermal emissivity of the invented graphene foam particles enables good radiation-based heat dissipation. Furthermore, the substantially spherical shape of graphene foam particles can result in a heat-dissipator or heat sink surface having micro-grooves for micro-convective flow for faster heat dissipation.

The graphene foam particle-based thermal management or heat dissipating devices include a heat exchanger, a heat sink (e.g. finned heat sink), a heat pipe, high-conductivity insert, thin or thick conductive plate (between a heat sink and a heat source), thermal interface medium thermal interface material, TIM), thermoelectric or Peltier cooling plate, etc.

A heat exchanger is a device used to transfer heat between one or more fluids; e.g. a gas and a liquid separately flowing in different channels. The fluids are typically separated by a solid wall to prevent mixing. The presently invented graphene foam particles, along with a resin binder, may be sprayed over surfaces of a heat exchanger as a heat dissipation-enhancing coating, for instance.

Heat exchangers are widely used in refrigeration systems, air conditioning units, heaters, power stations, chemical plants, petrochemical plants, petroleum refineries, natural-gas processing, and sewage treatment. A well-known example of a heat exchanger is found in an internal combustion engine in which a circulating engine coolant flows through radiator coils while air flows past the coils, which cools the coolant and heats the incoming air. The solid walls (e.g. that constitute the radiator coils) are normally made of a high thermal conductivity material, such as Cu and Al. The presently invented graphene balls, having either a higher thermal conductivity or higher specific surface area, are a superior alternative to Cu and Al, for instance, There are many types of heat exchangers that are commercially available: shell and tube heat exchanger, plate heat exchangers, plate and shell heat exchanger, adiabatic wheel heat exchanger, plate fin heat exchanger, pillow plate heat exchanger, fluid heat exchangers, waste heat recovery units, dynamic scraped surface heat exchanger, phase-change heat exchangers, direct contact heat exchangers, and microchannel heat exchangers. Every one of these types of heat exchangers can take advantage of the exceptional high thermal conductivity and specific surface area of the presently invented graphene ball material.

The presently invented solid graphene foam particles can also be used in a heat sink. Heat sinks are widely used in electronic devices for heat dissipation purposes. The central processing unit (CPU) and battery in a portable microelectronic device (such as a notebook computer, tablet, and smart phone) are well-known heat sources. Typically, a metal or graphite object (e.g. Cu foil or graphite foil) is brought into contact with the hot surface and this object helps to spread the heat to an external surface or outside air (primarily by conduction and convection and to a lesser extent by radiation). In most cases, a thin thermal interface material (TIM) mediates between the hot surface of the heat source and a heat spreader or a heat-spreading surface of a heat sink.

Compared to individual graphene sheets, graphene foam particles, in a particulate form, are easier and more convenient to be inserted into channels between a heat sink and a heat source A heat sink usually includes a high-conductivity material structure with one or more flat surfaces to ensure good thermal contact with the components to be cooled, and an array of comb or fin like protrusions to increase the surface contact with the air, and thus the rate of heat dissipation. A heat sink may be used in conjunction with a fan to increase the rate of airflow over the heat sink. A heat sink can have multiple fins (extended or protruded surfaces) to improve heat transfer. In electronic devices with limited amount of space, the shape/arrangement of fins should be optimized such that the heat transfer density is maximized. Alternatively or additionally, cavities (inverted fins) may be embedded in the regions formed between adjacent fins. These cavities are effective in extracting heat from a variety of heat generating bodies to a heat sink.

Typically, an integrated heat sink comprises a heat collection member (core or base) and at least one heat dissipation member (e.g. a fin or multiple fins) integral to the heat collection member (base) to form a finned heat sink. The fins and the core are naturally connected or integrated together into a unified body without using an externally applied adhesive or mechanical fastening means to connect the fins to the core. The heat collection base has a surface in thermal contact with a heat source (e.g. a LED), collects heat from this heat source, and dissipates heat through the fins into the air.

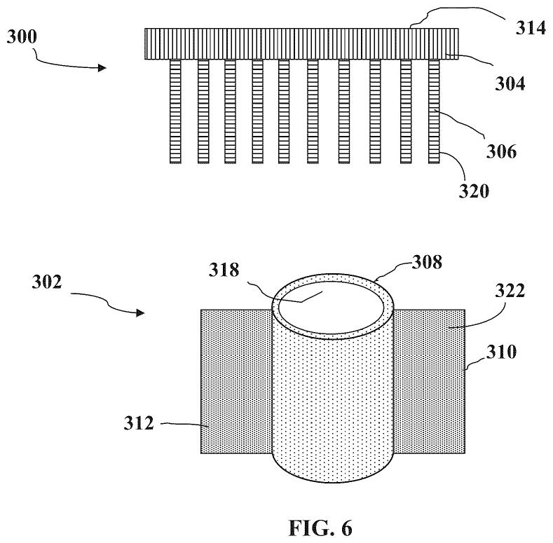

As illustrative examples, FIG. 6 provides a schematic of two heat sinks: 300 and 302. The first one contains a heat collection member (or base member) 304 and multiple fins or heat dissipation members (e.g. fin 306) connected to the base member 304. The base member 304 is shown to have a heat collection surface 314 intended to be in thermal contact with a heat source. The heat dissipation member or fin 306 is shown to have at least a heat dissipation surface 320. A particularly useful embodiment is an integrated radial heat sink 302 comprising a radial finned heat sink assembly that comprises: (a) a base 308 comprising a heat collection surface 318; and (b) a plurality of spaced parallel planar fin members (e.g. 310, 312 as two examples) supported by or integral with the base 308, wherein the planar fin members (e.g. 310) comprise the at least one heat dissipation surface 322. Multiple parallel planar fin members are preferably equally spaced.

The presently invented graphene foam particles of micron or nanometer sizes can be an additive in the structure of any finned heat sink element, or simply an ingredient of a heat-dissipating coating of any element. The graphene foam particles, being highly elastic and resilient, are a good thermal interface material and a highly effective heat spreading element as well. In addition, these high-conductivity graphene foam particles can also be used as an insert for electronic cooling and for enhancing the heat removal from small chips to a heat sink.

Because the space occupied by high conductivity materials is a major concern, it is a more efficient design to make use of high conductivity pathways that can be embedded into a heat generating body. The elastic and highly conducting graphene foam particles herein disclosed meets these requirements perfectly.

The high elasticity and high thermal conductivity make the presently invented solid graphene foam particles (made into a compact with or without a binder) a good conductive thick plate to be placed as a heat transfer interface between a heat source and a cold flowing fluid (or any other heat sink) to improve the cooling performance. In such an arrangement, the heat source is cooled under the thick graphene foam particle-based plate instead of being cooled in direct contact with the cooling fluid. The thick plate of graphene foam particles can significantly improve the heat transfer between the heat source and the cooling fluid by way of conducting the heat current in an optimal manner. No additional pumping power and no extra heat transfer surface area are required.

The graphene foam particles may also be coated onto selected surfaces of a heat pipe. In addition, graphene foam particles can be used as a wick material inside a heat pipe. A heat pipe is a heat transfer device that uses evaporation and condensation of a two-phase working fluid or coolant to transport large quantities of heat with a very small difference in temperature between the hot and cold interfaces. A conventional heat pipe includes a sealed hollow tube made of a thermally conductive metal such as Cu or Al, and a wick to return the working fluid from the evaporator to the condenser. The pipe contains both of the saturated liquid and vapor of a working fluid (such as water, methanol or ammonia), all other gases being excluded. However, both Cu and Al are prone to oxidation or corrosion and, hence, their performance degrades relatively fast over time. In contrast, the invented solid graphene foam particles are chemically inert and do not have these oxidation or corrosion issues. The heat pipe for electronics thermal management can have a solid graphene foam envelope and wick, with water as the working fluid. Graphene/methanol may be used if the heat pipe needs to operate below the freezing point of water, and graphene/ammonia heat pipes may be used for electronics cooling in space.

Peltier cooling plates operate on the Peltier effect to create a heat flux between the junction of two different conductors of electricity by applying an electric current. This effect is commonly used for cooling electronic components and small instruments. In practice, many such junctions may be arranged in series to increase the effect to the amount of heating or cooling required. The solid graphene balls may be used to improve the heat transfer efficiency.

### Filtration and Fluid Absorption Applications

The graphene foam particles and a solid compact element containing graphene foam particles compacted together can contain microscopic pores (<2 nm) or meso-scaled pores having a pore size from 2 nm to 50 nm. They can also be made to contain micron-scaled pores (1-500 μm) where necessary. Based on well-controlled pore size alone, the instant graphene ball products can be an exceptional filter material for air or water filtration.

Further, the graphene wall chemistry and the bonding carbon/polymer phase chemistry can be independently controlled to impart different amounts and/or types of functional groups to either or both of the graphene and the carbon/polymer binder phase (e.g. as reflected by the percentage of O, F, N, H, etc. in the foam). In other words, the concurrent or independent control of both pore sizes and chemical functional groups at different sites of the internal structure provide unprecedented flexibility or highest degree of freedom in designing and making graphene foam particles that exhibit many unexpected properties, synergistic effects, and some unique combination of properties that are normally considered mutually exclusive (e.g. some part of the structure is hydrophobic and other part hydrophilic; or the compact structure containing graphene foam particles can be both hydrophobic and oleophilic). A surface or a material is said to be hydrophobic if water is repelled from this material or surface and that a droplet of water placed on a hydrophobic surface or material will form a large contact angle. A surface or a material is said to be oleophilic if it has a strong affinity for oils and not for water. The present method allows for precise control over hydrophobicity, hydrophilicity, and oleophilicity of an object containing multiple types of graphene foam particles.

The present disclosure also provides an oil-removing, oil-separating, or oil-recovering device, which contains the presently invented graphene foam particles as an oil-absorbing or oil-separating element. Also provided is a solvent-removing or solvent-separating device containing the graphene foam particles as a solvent-absorbing element.

A major advantage of using the instant graphene foam particles as an oil-absorbing element is its structural integrity. Due to the notion that graphene sheets in the foam particles are either self-bonded or chemically bonded by a carbon or polymer material, the resulting foam particles would not get disintegrated upon repeated oil absorption operations. In contrast, we have discovered that graphene-based oil-absorbing elements prepared by hydrothermal reduction, vacuum-assisted filtration, or freeze-drying get disintegrated after absorbing oil for 2 or 3 times. There is just nothing (other than weak van der Waals forces existing prior to first contact with oil) to hold these otherwise separated graphene sheets together. Once these graphene sheets are wetted by oil, they no longer are able to return to the original shape of the oil-absorbing element.

Another major advantage of the instant technology is the flexibility in designing and making oil-absorbing elements that are capable of absorbing oil up to an amount as high as 400 times of its own weight yet still maintaining its structural shape (without significant expansion). This amount depends upon the specific pore volume of the foam particles, which can be controlled mainly by the ratio between the amount of polymer or carbon precursor and the amount of graphene sheets prior to the heat treatment.

The disclosure also provides a method to separate/recover oil from an oil-water mixture (e.g. oil-spilled water or waste water from oil sand). The method comprises the steps of (a) providing an oil-absorbing element (member) comprising the invented graphene foam particles; (b) contacting an oil-water mixture with the element, which absorbs the oil from the mixture; and (c) retreating the oil-absorbing element from the mixture and extracting the oil from the element. Preferably, the method comprises a further step of (d) reusing the element.

Additionally, the disclosure provides a method to separate an organic solvent from a solvent-water mixture or from a multiple-solvent mixture. The method comprises the steps of (a) providing an organic solvent-absorbing element comprising multiple graphene balls, separately or bonded together; (b) bringing the element in contact with an organic solvent-water mixture or a multiple-solvent mixture containing a first solvent and at least a second solvent; (c) allowing this element to absorb the organic solvent from the mixture or absorb the first solvent from the at least second solvent; and (d) retreating the element from the mixture and extracting the organic solvent or first solvent from the element. Preferably, the method contains an additional step (e) of reusing the solvent-absorbing element.

In summary, the disclosure provides a filtration or separation device comprising a filtration, separation, or absorbing member that comprises the disclosed multiple graphene foam particles. For instance, the device may be an oil-removing or oil-separating device comprising the multiple graphene foam particles as an oil-absorbing agent. The filtration or separation device may be a solvent-removing or solvent-separating device comprising said mass of multiple graphene foam particles as a solvent-absorbing agent. The filtration or separation device may be a contaminant-removing or contaminant-separating device containing the disclosed graphene foam particles as a contaminant-absorbing agent. The filtration or separation device may be an air filter or a water purifier. In the water purification, for instance, the disclosed device is capable of capturing and separating contaminants, such as pharmaceutical chemicals, anionic and cationic dyes, heavy metals, pharmaceutical chemicals, and per-and polyfluoroalkyl substances (PFAS).

The disclosure further provides a method to separate oil from water, the method comprising the steps of: a) providing an oil-absorbing member comprising the disclosed mass of multiple graphene foam; b) contacting an oil-water mixture with said member, which absorbs the oil from the mixture; and c) retreating the member from the mixture and extracting the oil from the member. The method further comprises a step of reusing the member.

The disclosure also provides a method to separate an organic solvent from a solvent-water mixture or from a multiple-solvent mixture, the method comprising the steps of: a) providing an organic solvent-absorbing or solvent-separating member comprising the disclosed graphene foam particles; b) bringing said member in contact with an organic solvent-water mixture or a multiple-solvent mixture containing a first solvent and at least a second solvent; c) allowing the member to absorb the organic solvent from the mixture or separate the first solvent from the at least second solvent; and d) retreating the member from the mixture and extracting the organic solvent or first solvent from the member. The method may further comprise a step of reusing the member.

### Acoustic Wave Absorption and Vibration Damping Control

The presently disclosed graphene foam particles can be used to significantly reduce vibration damping by incorporating them into composite materials, where their unique high surface area and strong inter-layer interactions create internal friction, effectively dissipating vibrational energy as heat when subjected to mechanical stress, this makes graphene foam particles a promising material for vibration damping applications, especially when combined with polymers or other matrices to form nanocomposites.

When vibrations occur within a graphene-based composite, the graphene sheets slide against each other at the interfaces, generating friction which absorbs energy and dampens the vibration. Graphene's large surface area and high aspect ratio enable efficient energy dissipation, leading to superior vibration damping compared to many conventional materials. Due to the low-density feature, graphene foam particles can be added to composites without significantly increasing the overall weight. By adjusting the concentration and morphology of graphene within the matrix, the damping properties can be customized for specific applications.

Incorporating graphene foam particles into structural materials, such as polymer composites, can improve the vibration damping capabilities of aircraft, automobiles, and machinery. Additionally, graphene foam particles can be used to create high-performance vibration isolation pads. Graphene foam particles can be integrated into electronic devices to reduce unwanted vibrations and improve their performance.

Achieving proper dispersion of graphene foam particles within the matrix material and strong interfacial bonding is crucial for optimal damping performance. Modifying graphene with functional groups can further enhance its interaction with the matrix, improving damping properties.

The presently disclosed 3D graphene particles can be designed to possess high porosity and ultra-low-density interconnected pores, making them excellent for acoustic absorption. Due to the high elastic modulus and ability to break spatial symmetry through electrostatic interaction, graphene exhibits rich vibrational properties when subjected to force. This makes it a promising material for nano-devices such as high-quality surface plasmon resonance transducers and oscillators and for preparing high-performance acoustic absorption materials.

The disclosed graphene foam particles can be combined with with other materials (e.g., polyurethane foam, SBR rubber, etc.) to reduce low-frequency sound vibration and delay the propagation of sound wave. This is achieved using graphene's unique resonance effect and nonlinear damping properties. This effectively solves the problem of current sound-absorbing materials, which are difficult to use for low-frequency and high-frequency acoustic absorption.

Graphene-based sound-absorbing materials are classified into monolithic and binary and ternary composite sound-absorbing materials based on the number of main sound-absorbing components in the composite system. The disclosed graphene foam particles can be utilized in all types of sound-absorbing materials.

### Electromagnetic Wave and Radiation Absorption Applications

Graphene foam particles, comprising multi-and monolayers of graphene, and functionalized graphene oxide or porous composites comprising these particles (e.g., polymer/graphene foam particle composites) may be utilized in electromagnetic interference shielding applications such as radio wave, X-ray, microwave, and UV shielding.

Commonly used materials for protection against ionizing radiation (gamma and X-ray energy range) primarily rely on high-density materials, such as lead, steel, or tungsten. However, these materials are heavy and often impractical for various applications, especially where weight is a key parameter, like in avionics or space technology.

Graphene exhibits a unique ability to absorb radiation, particularly in the infrared and terahertz range, due to its unique electronic structure and atomically thin nature, making it a promising material for applications like radiation shielding and highly sensitive detectors, even though its individual atomic carbon components do not readily absorb radiation on their own.

This absorption is significantly enhanced when graphene is structured or patterned to manipulate plasmonic resonances or electromagnetic wave incidence direction and reflection/transmission characteristics.

Despite being only one atom thick, graphene can absorb a significant portion of incident radiation across a wide range of frequencies, especially in the mid-infrared to far-infrared spectrum. By adjusting the Fermi level of graphene through doping, one can control the absorption characteristics to target specific wavelengths. For visible wavelengths, a single-layer graphene sheet allows 97.3% of light to pass through. But, by assembling graphene sheets into secondary particle form, the resulting graphene foam particles can absorb substantially all the wavelengths. Graphene's ability to support surface plasmon waves, collective oscillations of electrons on its surface, is crucial for enhancing radiation absorption, particularly when designed with specific patterns or structures.

Examples of application devices include (1) infrared detectors; highly sensitive infrared detectors due to strong absorption in the mid-infrared range; (2) electromagnetic interference (EMI) shielding; graphene-based coatings can effectively block electromagnetic radiation across a wide frequency range; (3) optical modulators: controlling light absorption for light modulation applications; and (4) radiation protection; graphene-foam particles can be used for shielding against ionizing radiation like X-rays and gamma rays.

The presently invented solid graphene foam particles may be produced by a process comprising: (a) preparing a graphene dispersion having multiple sheets of a starting graphene material dispersed in a liquid medium, wherein said starting graphene material is selected from a pristine graphene, having a content of non-carbon elements no greater than 0.01%, or a non-pristine graphene material, having a content of non-carbon elements greater than 0.01% by weight, selected from graphene oxide, reduced graphene oxide, graphene fluoride, graphene chloride, graphene bromide, graphene iodide, hydrogenated graphene, nitrogenated graphene, chemically functionalized graphene, or a combination thereof and wherein said dispersion comprises an optional polymer having a polymer-to-graphene material weight ratio from 0/1.0 to 20/1.0 and/or an optional blowing agent having a blowing agent-to-graphene material weight ratio from 0/1.0 to 1.0/1.0; (b) forming and drying the graphene dispersion into multiple graphene foam particles; and (c) heat treating the multiple graphene foam particles at a first heat treatment temperature from 30° C. to 3,200° C. at a desired heating rate sufficient to induce volatile gas molecules from the non-carbon elements (e.g. O, H, N, B, F, Cl, Br, I, etc.) or to activate the blowing agent for producing said solid mass of graphene foam particles. The resulting solid graphene foam particles typically have a density from 0.001 to 1.7 g/cm³ (more typically from 0.01 to 1.5g/cm³, and even more typically from 0.1 to 1.0g/cm³, and most typically from 0.2 to 0.75g/cm³), or a specific surface area from 50 to 3,000m²/g (more typically from 200 to 2,000 m²/g, and most typically from 500 to 1,500m²/g).

A blowing agent or foaming agent is a substance which is capable of producing a cellular or foamed structure via a foaming process in a variety of materials that undergo hardening or phase transition, such as polymers (plastics and rubbers), glass, and metals. They are typically applied when the material being foamed is in a liquid state. It has not been previously known that blowing agent can be used to create a foamed particle material while in a solid state. More significantly, it has not been taught or hinted that an aggregate of sheets of a graphene material can be converted into graphene foam particles via a blowing agent.

Blowing agents or related foaming mechanisms to create pores or cells (bubbles) in a matrix for producing a foamed or cellular material, can be classified into the following groups:
(a) Physical blowing agents: e.g. hydrocarbons (e.g. pentane, isopentane, cyclopentane), chlorofluorocarbons (CFCs), hydrochlorofluorocarbons (HCFCs), and liquid CO₂. The bubble/foam-producing process is endothermic, i.e. it needs heat (e.g. from a melt process or the chemical exotherm due to cross-linking), to volatize a liquid blowing agent.
(b) Chemical blowing agents: e.g. isocyanate, azo-, hydrazine and other nitrogen-based materials (for thermoplastic and elastomeric foams), sodium bicarbonate (e.g. baking soda, used in thermoplastic foams). Here gaseous products and other by-products are formed by a chemical reaction, promoted by process or a reacting polymer's exothermic heat. Since the blowing reaction involves forming low molecular weight compounds that act as the blowing gas, additional exothermic heat is also released. Powdered titanium hydride is used as a foaming agent in the production of metal foams, as it decomposes to form titanium and hydrogen gas at elevated temperatures. Zirconium (II) hydride is used for the same purpose. Once formed the low molecular weight compounds will never revert to the original blowing agent(s), i.e. the reaction is irreversible.
(c) Mixed physical/chemical blowing agents: e.g. used to produce flexible polyurethane (PU) foams with very low densities. Both the chemical and physical blowing can be used in tandem to balance each other out with respect to thermal energy released/absorbed; hence, minimizing temperature rise. For instance, isocyanate and water (which react to form CO₂) are used in combination with liquid CO₂ (which boils to give gaseous form) in the production of very low density flexible PU foams for mattresses.
(d) Mechanically injected agents: Mechanically made foams involve methods of introducing bubbles into liquid polymerizable matrices (e.g. an unvulcanized elastomer in the form of a liquid latex). Methods include whisking-in air or other gases or low boiling volatile liquids in low viscosity lattices, or the injection of a gas into an extruder barrel or a die, or into injection molding barrels or nozzles and allowing the shear/mix action of the screw to disperse the gas uniformly to form very fine bubbles or a solution of gas in the melt. When the melt is molded or extruded and the part is at atmospheric pressure, the gas comes out of solution expanding the polymer melt immediately before solidification.
(e) Soluble and leachable agents: Soluble fillers, e.g. solid sodium chloride crystals mixed into a liquid urethane system, which is then shaped into a solid polymer part, the sodium chloride is later washed out by immersing the solid molded part in water for some time, to leave small inter-connected holes in relatively high density polymer products.
(f) We have found that the above five mechanisms can all be used to create pores in the graphene materials while they are in a solid state. Another mechanism of producing pores in a graphene material is through the generation and vaporization of volatile gases by removing those non-carbon elements in a high-temperature environment. This is a unique self-foaming process that has never been previously taught or suggested.

This optional blowing agent is not required if the graphene material has a content of non-carbon elements (e.g. O, H, N, B, F, Cl, Br, I, etc.) no less than 5% by weight (preferably no less than 10%, further preferably no less than 20%, even more preferably no less than 30% or 40%, and most preferably up to 57%). The subsequent high temperature treatment serves to remove a majority of these non-carbon elements from the graphene material, generating volatile gas species that produce pores or cells in the solid graphene material structure. In other words, quite surprisingly, these non-carbon elements play the role of a blowing agent. Hence, an externally added blowing agent is optional (not required). However, the use of a blowing agent can provide added flexibility in regulating or adjusting the porosity level and pore sizes for a desired application. The blowing agent is typically required if the non-carbon element content is less than 5%, such as pristine graphene that is essentially all-carbon.

In a preferred embodiment, the graphene material in the dispersion is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof. The starting graphitic material for producing any one of the above graphene materials may be selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof. For instance, as discussed in the Background section, the graphene oxide (GO) may be obtained by immersing powders or filaments of a starting graphitic material (e.g. natural graphite powder) in an oxidizing liquid medium (e.g. a mixture of sulfuric acid, nitric acid, and potassium permanganate) in a reaction vessel at a desired temperature for a period of time (typically from 0.5 to 96 hours, depending upon the nature of the starting material and the type of oxidizing agent used). The resulting graphite oxide particles may then be subjected to thermal exfoliation or ultrasonic wave-induced exfoliation to produce GO sheets.

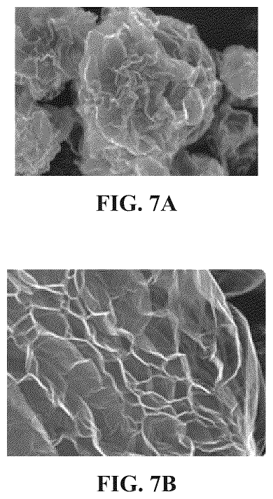

Pristine graphene may be produced by direct ultrasonication (also known as liquid phase production) or supercritical fluid exfoliation of graphite particles. These processes are well-known in the art. Multiple pristine graphene sheets may be dispersed in water or other liquid medium with the assistance of a surfactant to form a suspension. A chemical blowing agent may then be dispersed into the dispersion. This suspension is then spray-dried into secondary graphene particles (e.g., similar to FIG. 7A). When heated to a desired temperature, the chemical blowing agent is activated or decomposed to generate volatile gases (e.g. N₂ or CO₂), which act to form bubbles or pores in an otherwise mass of solid graphene sheets, forming a pristine graphene foam.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated, including trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

In the disclosed process, step (b) may comprise a procedure selected from spray-drying, spray cooling, fluidized bed particle treatment, extrusion and fiber fragmentation, pan coating, centrifuge-induced particle formation, self-assembling of graphene sheets, air-suspension coating, freeze-drying, centrifugal extrusion, vibration nozzle coating, hydrothermal encapsulation, supercritical fluid coating, or in-situ polymerization.

The pore walls (cell walls) in the presently invented graphene foam particles contain chemically bonded and merged graphene planes. These planar aromatic molecules or graphene planes (hexagonal structured carbon atoms) are well interconnected physically and chemically.

The lateral dimensions (length or width) of these planes are huge (from 20 nm to >10 μm), typically several times or even orders of magnitude larger than the maximum crystallite dimension (or maximum constituent graphene plane dimension) of the starting graphite particles. The graphene sheets or planes in the graphene foam particles are essentially interconnected to form electron-conducting pathways with low resistance. This is a unique and new class of material that has not been previously discovered, developed, or suggested to possibly exist.

In order to illustrate how the presently invented process works to produce a mass of multiple graphene foam particles, we herein make use of graphene oxide (GO) and graphene fluoride (GF) as two examples. These should not be construed as limiting the scope of our claims. In each case, the first step involves preparation of a graphene dispersion (e.g. GO+water or GF+organic solvent, DMF) containing an optional blowing agent and/or optional polymer. If the graphene material is pristine graphene containing no non-carbon elements, a blowing agent or a polymer is normally needed.

In step (b), the GF or GO suspension may be formed into a GF or GO particles (e.g., FIG. 7(A)) using a process such as spray-drying or pan coating.

In an embodiment, this GF or GO layer is then subjected to a heat treatment to activate the blowing agent and/or the thermally-induced reactions that remove the non-carbon elements (e.g. F, O, etc.) from the graphene sheets to generate volatile gases as by-products. These volatile gases generate pores or bubbles inside the solid graphene material, pushing solid graphene sheets into a wall structure, forming a graphene oxide foam particle (e.g., FIG. 7(B)). If no blowing agent is added, the non-carbon elements in the graphene material preferably occupy at least 10% by weight of the graphene material (preferably at least 20%, and further preferably at least 30%). The first (initial) heat treatment temperature is typically greater than 80° C., preferably greater than 100° C., more preferably greater than 300° C., further more preferably greater than 500° C. and can be as high as 1,500° C. The blowing agent is typically activated at a temperature from 80° C. to 300° C., but can be higher. The foaming procedure (formation of pores, cells, or bubbles) is typically completed within the temperature range of 80-1,500° C. Quite surprisingly, the chemical linking or merging between graphene planes (GO or GF planes) in an edge-to-edge and/or face-to-face manner can occur at a relatively low heat treatment temperature (e.g. as low as from 150 to 300° C.).

The foamed graphene particles may be subjected to a further heat treatment that involves at least a second temperature that is significantly higher than the first heat treatment temperature. A properly programmed heat treatment procedure can involve just a single heat treatment temperature (e.g. a first heat treatment temperature only), at least two heat treatment temperatures (first temperature for a period of time and then raised to a second temperature and maintained at this second temperature for another period of time), or any other combination of heat treatment temperatures (HTT) that involve an initial treatment temperature (first temperature) and a final HTT (second), higher than the first. The highest or final HTT that the dried graphene layer experiences may be divided into four distinct HTT regimes:
Regime 1 (80° C. to 300° C.): In this temperature range (the thermal reduction regime and also the activation regime for a blowing agent, if present), a GO or GF layer primarily undergoes thermally-induced reduction reactions, leading to a reduction of oxygen content or fluorine content from typically 20-57% (of O in GO) or 10-25% (of F in GF) to approximately 5-6%. This treatment results in a reduction of inter-graphene spacing in foam walls from approximately 0.6-1.2 nm (as dried) down to approximately 0.4 nm, and an increase in thermal conductivity to 200 W/mK per unit specific gravity and/or electrical conductivity to 2,000 S/cm per unit of specific gravity. (Since one can vary the level of porosity and, hence, specific gravity of a graphene foam particle material and, given the same graphene material, both the thermal conductivity and electric conductivity values vary with the specific gravity, these property values should be divided by the specific gravity to facilitate a fair comparison.) Even with such a low temperature range, some chemical linking between graphene sheets occurs. The inter-GO or inter-GF planar spacing remains relatively large (0.4 nm or larger). Many O- or F-containing functional groups survive.
Regime 2 (300° C.-1,500° C.): In this chemical linking regime, extensive chemical combination, polymerization, and cross-linking between adjacent GO or GF sheets in a secondary graphene particle occur. The oxygen or fluorine content is reduced to typically <1.0% (e.g. 0.7%) after chemical linking, resulting in a reduction of inter-graphene spacing to approximately 0.345 nm. This implies that some initial re-graphitization has already begun at such a low temperature, in stark contrast to conventional graphitizable materials (such as carbonized polyimide film) that typically require a temperature as high as 2,500° C. to initiate graphitization. This is another distinct feature of the presently invented graphene foam and its production processes. These chemical linking reactions result in an increase in thermal conductivity to 250 W/mK per unit of specific gravity, and/or electrical conductivity to 2,500-4,000 S/cm per unit of specific gravity.
Regime 3 (1,500-2,500° C.): In this ordering and re-graphitization regime, extensive graphitization or graphene plane merging occurs, leading to significantly improved degree of structural ordering in the foam walls. As a result, the oxygen or fluorine content is reduced to typically 0.01% and the inter-graphene spacing to approximately 0.337 nm (achieving degree of graphitization from 1% to approximately 80%, depending upon the actual HTT and length of time). The improved degree of ordering is also reflected by an increase in thermal conductivity to >350 W/mK per unit of specific gravity, and/or electrical conductivity to >3,500 S/cm per unit of specific gravity.
Regime 4 (higher than 2,500° C.): In this re-crystallization and perfection regime, extensive movement and elimination of grain boundaries and other defects occur, resulting in the formation of nearly perfect single crystals or poly-crystalline graphene crystals with huge grains in the foam walls, which can be orders of magnitude larger than the original grain sizes of the starting graphite particles for the production of GO or GF. The oxygen or fluorine content is essentially eliminated, typically 0%-0.001%. The inter-graphene spacing is reduced to down to approximately 0.3354 nm (degree of graphitization from 80% to nearly 100%), corresponding to that of a perfect graphite single crystal. The foamed structure thus obtained exhibits a thermal conductivity of >400 W/mK per unit of specific gravity, and electrical conductivity of >4,000 S/cm per unit of specific gravity.

The presently invented graphene foam particle structure can be obtained by heat-treating the dried GO or GF powder with a temperature program that covers at least the first regime (typically requiring 1-4 hours in this temperature range if the temperature never exceeds 500° C.), more commonly covers the first two regimes (1-2 hours preferred), still more commonly the first three regimes (preferably 0.5-2.0 hours in Regime 3), and can cover all the 4 regimes (including Regime 4 for 0.2 to 1 hour, may be implemented to achieve the highest conductivity).

If the graphene material is selected from the group of non-pristine graphene materials consisting of graphene oxide, reduced graphene oxide, graphene fluoride, graphene chloride, graphene bromide, graphene iodide, hydrogenated graphene, nitrogenated graphene, chemically functionalized graphene, or a combination thereof, and wherein the maximum heat treatment temperature (e.g. both the first and second heat treatment temperatures) is (are) less than 2,500° C., then the resulting solid graphene foam particles typically contain a content of non-carbon elements in the range of 0.01% to 2.0% by weight (non-pristine graphene foam).

X-ray diffraction patterns were obtained with an X-ray diffractometer equipped with CuKcv radiation. The shift and broadening of diffraction peaks were calibrated using a silicon powder standard. The degree of graphitization, g, was calculated from the X-ray pattern using the Mering's Eq, d₀₀₂=0.3354 g+0.344 (1−g), where d₀₀₂ is the interlayer spacing of graphite or graphene crystal in nm. This equation is valid only when d₀₀₂ is equal or less than approximately 0.3440 nm. The graphene foam walls having a doo higher than 0.3440 nm reflects the presence of oxygen- or fluorine-containing functional groups (such as —F, —OH, >O, and —COOH on graphene molecular plane surfaces or edges) that act as a spacer to increase the inter-graphene spacing.

Another structural index that can be used to characterize the degree of ordering of the stacked and bonded graphene planes in the foam walls of graphene and conventional graphite crystals is the “mosaic spread,” which is expressed by the full width at half maximum of a rocking curve (X-ray diffraction intensity) of the (002) or (004) reflection. This degree of ordering characterizes the graphite or graphene crystal size (or grain size), amounts of grain boundaries and other defects, and the degree of preferred grain orientation. A nearly perfect single crystal of graphite is characterized by having a mosaic spread value of 0.2-0.4. Most of our graphene walls have a mosaic spread value in this range of 0.2-0.4 (if produced with a heat treatment temperature (HTT) no less than 2,500° C.). However, some values are in the range of 0.4-0.7 if the HTT is between 1,500 and 2,500° C., and in the range of 0.7-1.0 if the HTT is between 300 and 1,500° C.

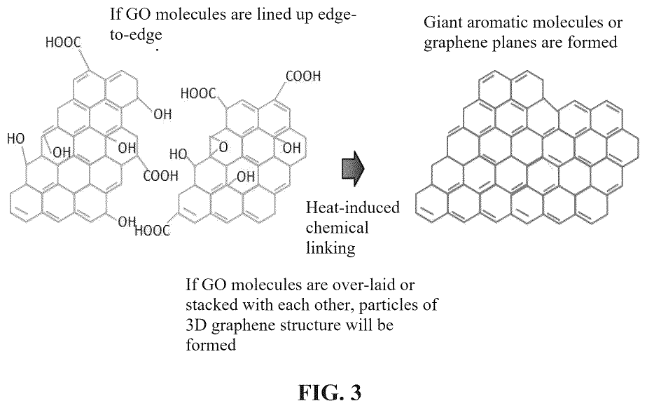

Illustrated in FIG. 3 is a plausible chemical linking mechanism where only 2 aligned GO molecules are shown as an example, although a large number of GO molecules (aligned edge to edge) can be chemically linked together to form a foam wall. Further, chemical linking could also occur face-to-face (GO molecules stacked together), not just edge-to-edge for GO, GF, and chemically functionalized graphene sheets. These linking and merging reactions proceed in such a manner that the molecules are chemically merged, linked, and integrated into one single entity (3D graphene structure). The graphene sheets (GO or GF sheets) completely lose their own original identity and they no longer are discrete sheets/platelets/flakes. The resulting product is not a simple aggregate of individual graphene sheets, but a single entity that is essentially a network of interconnected giant molecules with an essentially infinite molecular weight. This may also be described as a graphene poly-crystal (with several grains, but typically no discernible, well-defined grain boundaries). All the constituent graphene planes are very large in lateral dimensions (length and width) and, if the HTT is sufficiently high (e.g. >1,500° C. or much higher), these graphene planes are essentially bonded together with one another.

In-depth studies using a combination of SEM, TEM, selected area diffraction, X-ray diffraction, AFM, Raman spectroscopy, and FTIR indicate that the graphene particle foam walls are composed of several huge graphene planes (with length/width typically »20 nm, more typically »100 nm, often »1 μm, and, in many cases, »10 μm, or even »100 μm). These giant graphene planes are stacked and bonded along the thickness direction (crystallographic c-axis direction) often through not just the van der Waals forces (as in conventional graphite crystallites), but also covalent bonds, if the final heat treatment temperature is lower than 2,500° C. In these cases, wishing not to be limited by theory, but Raman and FTIR spectroscopy studies appear to indicate the co-existence of sp² (dominating) and sp³ (weak but existing) electronic configurations, not just the conventional sp² in graphite.
(1) This graphene foam wall is not made by gluing or bonding discrete flakes/platelets together with a resin binder, linker, or adhesive. Instead, GO sheets (molecules) from the GO dispersion or the GF sheets from the GF dispersion are merged through joining or forming of covalent bonds with one another, into an integrated graphene entity, without using any externally added linker or binder molecules or polymers.
(2) This graphene foam wall is typically a poly-crystal composed of large grains having incomplete grain boundaries. This entity is derived from a GO or GF suspension, which is in turn obtained from natural graphite or artificial graphite particles originally having multiple graphite crystallites. Prior to being chemically oxidized or fluorinated, these starting graphite crystallites have an initial length (Lₐ in the crystallographic a-axis direction), initial width (L_{b} in the b-axis direction), and thickness (L_{c} in the c-axis direction). Upon oxidation or fluorination, these initially discrete graphite particles are chemically transformed into highly aromatic graphene oxide or graphene fluoride molecules having a significant concentration of edge-or surface-borne functional groups (e.g. —F, —OH, —COOH, etc.). These aromatic GO or GF molecules in the suspension have lost their original identity of being part of a graphite particle or flake. Upon removal of the liquid component from the suspension, the resulting GO or GF molecules form an essentially amorphous structure. Upon heat treatments, these GO or GF molecules are chemically merged and linked into a unitary or monolithic graphene entity that constitutes the foam wall. This foam wall is highly ordered.

The resulting unitary graphene entity in the foam wall typically has a length or width significantly greater than the Lₐ and L_{b} of the original crystallites. The length/width of this graphene foam wall entity is significantly greater than the Lₐ and L_{b} of the original crystallites. Even the individual grains in a poly-crystalline graphene wall structure have a length or width significantly greater than the Lₐ and L_{b} of the original crystallites.
(3) Due to these unique chemical composition (including oxygen or fluorine content), morphology, crystal structure (including inter-graphene spacing), and structural features (e.g. high degree of orientations, few defects, incomplete grain boundaries, chemical bonding and no gap between graphene sheets, and substantially no interruptions in graphene planes), the GO- or GF-derived graphene foam has a unique combination of outstanding thermal conductivity, electrical conductivity, mechanical strength, and stiffness (elastic modulus).

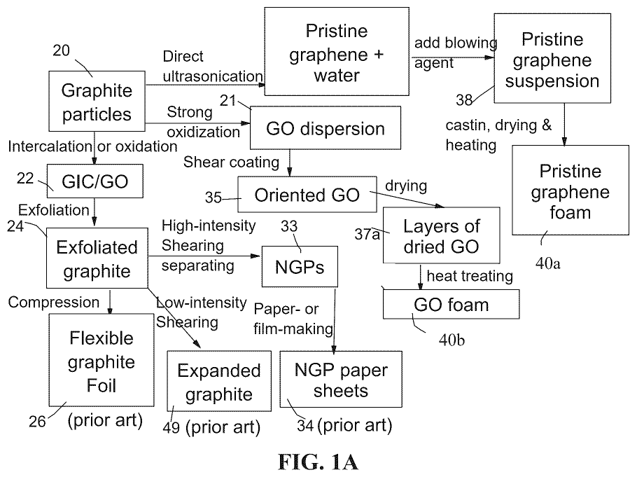

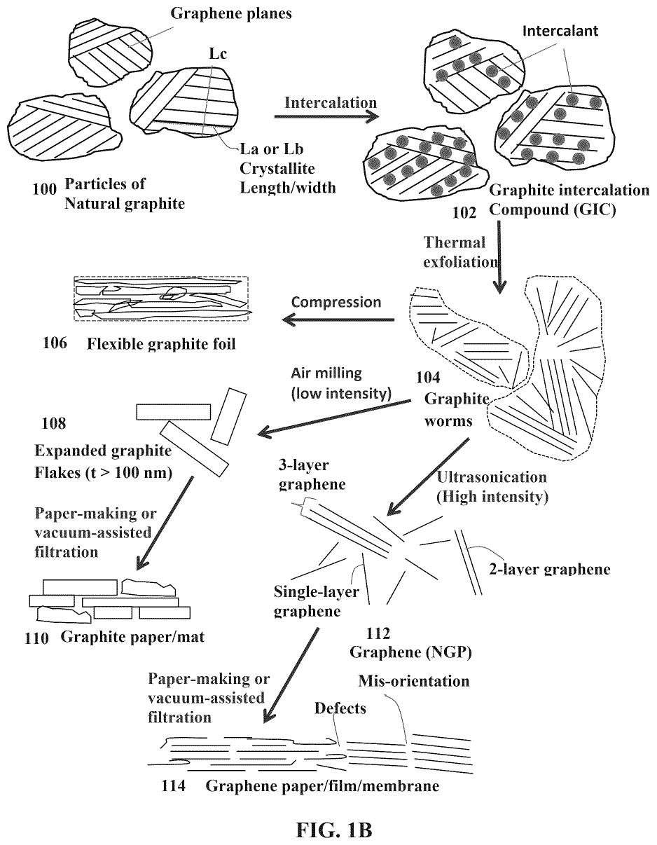

The aforementioned features are further described and explained in detail as follows: As illustrated in FIG. 1B, a graphite particle (e.g. 100) is typically composed of multiple graphite crystallites or grains. A graphite crystallite is made up of layer planes of hexagonal networks of carbon atoms. These layer planes of hexagonally arranged carbon atoms are substantially flat and are oriented or ordered so as to be substantially parallel and equidistant to one another in a particular crystallite. These layers of hexagonal-structured carbon atoms, commonly referred to as graphene layers or basal planes, are weakly bonded together in their thickness direction (crystallographic c-axis direction) by weak van der Waals forces and groups of these graphene layers are arranged in crystallites. The graphite crystallite structure is usually characterized in terms of two axes or directions: the c-axis direction and the a-axis (or b-axis) direction. The c-axis is the direction perpendicular to the basal planes. The a-or b-axes are the directions parallel to the basal planes (perpendicular to the c-axis direction).

A highly ordered graphite particle can include crystallites of a considerable size, having a length of Lₐ along the crystallographic a-axis direction, a width of L_{b} along the crystallographic b-axis direction, and a thickness L_{c} along the crystallographic c-axis direction. The constituent graphene planes of a crystallite are highly aligned or oriented with respect to each other and, hence, these anisotropic structures give rise to many properties that are highly directional. For instance, the thermal and electrical conductivity of a crystallite are of great magnitude along the plane directions (a- or b-axis directions), but relatively low in the perpendicular direction (c-axis). As illustrated in the upper-left portion of FIG. 1(B), different crystallites in a graphite particle are typically oriented in different directions and, hence, a particular property of a multi-crystallite graphite particle is the directional average value of all the constituent crystallites.

Due to the weak van der Waals forces holding the parallel graphene layers, natural graphite can be treated so that the spacing between the graphene layers can be appreciably opened up so as to provide a marked expansion in the c-axis direction, and thus form an expanded graphite structure in which the laminar character of the carbon layers is substantially retained. The process for manufacturing flexible graphite is well-known in the art. In general, flakes of natural graphite (e.g. 100 in FIG. 1B) are intercalated in an acid solution to produce graphite intercalation compounds (GICs, 102). The GICs are washed, dried, and then exfoliated by exposure to a high temperature for a short period of time. This causes the flakes to expand or exfoliate in the c-axis direction of the graphite up to 80-300 times of their original dimensions.

The exfoliated graphite flakes are vermiform in appearance and, hence, are commonly referred to as worms 104. These worms of graphite flakes which have been greatly expanded can be formed without the use of a binder into cohesive or integrated sheets of expanded graphite, e.g. webs, papers, strips, tapes, foils, mats or the like (typically referred to as “flexible graphite” 106) having a typical density of about 0.04-2.0 g/cm³ for most applications.

The upper left portion of FIG. IA shows a flow chart that illustrates the prior art processes used to fabricate flexible graphite foils. The processes typically begin with intercalating graphite particles 20 (e.g., natural graphite or synthetic graphite) with an intercalant (typically a strong acid or acid mixture) to obtain a graphite intercalation compound 22 (GIC).

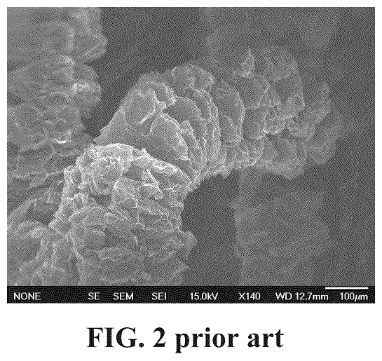

After rinsing in water to remove excess acid, the GIC becomes “expandable graphite.” The GIC or expandable graphite is then exposed to a high temperature environment (e.g., in a tube furnace preset at a temperature in the range of 800-1,050° C.) for a short duration of time (typically from 15 seconds to 2 minutes). This thermal treatment allows the graphite to expand in its c-axis direction by a factor of 30 to several hundreds to obtain a worm-like vermicular structure 24 (graphite worm), which contains exfoliated, but un-separated graphite flakes with large pores interposed between these interconnected flakes. An example of graphite worms is presented in FIG. 2.

In one prior art process, the exfoliated graphite (or mass of graphite worms) is re-compressed by using a calendaring or roll-pressing technique to obtain flexible graphite foils (26 in FIG. 1A or 106 in FIG. 1B), which are typically 100-300 μm thick. In another prior art process, the exfoliated graphite worm 24 may be impregnated with a resin and then compressed and cured to form a flexible graphite composite, which is normally of low strength as well. In addition, upon resin impregnation, the electrical and thermal conductivity of the graphite worms could be reduced by two orders of magnitude.

Alternatively, the exfoliated graphite may be subjected to high-intensity mechanical shearing/separation treatments using a high-intensity air jet mill, high-intensity ball mill, or ultrasonic device to produce separated nano graphene platelets 33 (NGPs) with all the graphene platelets thinner than 100 nm, mostly thinner than 10 nm, and, in many cases, being single-layer graphene (also illustrated as 112 in FIG. 1B). An NGP is composed of a graphene sheet or a plurality of graphene sheets with each sheet being a two-dimensional, hexagonal structure of carbon atoms. A mass of multiple NGPs (including discrete sheets/platelets of single-layer and/or few-layer graphene or graphene oxide, 33 in FIG. 1A) may be made into a graphene film/paper (34 in FIG. 1A or 114 in FIG. 1B) using a film-or paper-making process.

Further alternatively, with a low-intensity shearing, graphite worms tend to be separated into the so-called expanded graphite flakes (108 in FIG. 1B having a thickness >100 nm. These flakes can be formed into graphite paper or mat 106 using a paper-or mat-making process. This expanded graphite paper or mat 106 is just a simple aggregate or stack of discrete flakes having defects, interruptions, and mis-orientations between these discrete flakes.

In certain embodiments, the graphene dispersion in step (a) of the disclosed process comprises a polymer having a polymer-to-graphene material weight ratio from 0/1.0 to 20/1.0. The polymer may simply serve as an adhesive that bonds graphene sheets together. The polymer may serve as a solid substrate that can support certain chemical functional groups that are capable of attracting, capturing, or absorbing contaminant species such as pharmaceutical chemicals, anionic and cationic dyes, heavy metals, pharmaceutical chemicals, and PFAS. Alternatively, the polymer may serve as a precursor to carbon, which can serve as a binding agent.

Thus, in certain embodiments, the multiple graphene foam particles, after step (c), are impregnated with a polymer and the impregnated polymer bonds multiple graphene sheets in a graphene foam particle together.

In some embodiments, the multiple graphene foam particles, after step (c), are impregnated with a polymer and the process further comprises a step of heating the multiple graphene foam particles at a temperature for a period of time sufficient to convert the impregnated polymer into carbon that bonds multiple graphene sheets in a graphene foam particle together.

In certain preferred embodiments, the multiple graphene foam particles, after step (c), are subjected to a functionalization treatment to attach chemical functional groups to a surface or pore walls of a graphene particle.

The present disclosure also provides a process for producing the disclosed solid mass of multiple individual graphene foam particles, the process comprising: (a) preparing multiple graphene sheets; (b) applying a secondary particle-forming procedure to form multiple secondary particles from the multiple graphene sheets, wherein the multiple secondary particles comprise pores therein or comprise a polymer composite having a polymer binder or polymer matrix; and (c) heat treating the multiple secondary particles at a heat treatment temperature from 30° C. to 3,200° C. for producing the solid mass of graphene foam particles.

The secondary particle-forming procedure may comprise a procedure selected from spray-drying, spray cooling, fluidized bed particle treatment, extrusion and fiber fragmentation, pan coating, centrifuge-induced particle formation, self-assembling of graphene sheets, air-suspension coating, freeze-drying, centrifugal extrusion, vibration nozzle coating, hydrothermal encapsulation, supercritical fluid coating, or in-situ polymerization.

The following examples are used to illustrate some specific details about the best modes of practicing the instant invention and should not be construed as limiting the scope of the invention.

### EXAMPLE 1

### Various Blowing Agents and Pore-forming (Bubble-producing) Processes

In the field of plastic processing, chemical blowing agents are mixed into the plastic pellets in the form of powder or pellets and dissolved at higher temperatures. Above a certain temperature specific for blowing agent dissolution, a gaseous reaction product (usually nitrogen or CO₂) is generated, which acts as a blowing agent. However, a chemical blowing agent cannot be dissolved in a graphene material, which is a solid, not liquid. This presents a challenge to make use of a chemical blowing agent to generate pores or cells in a graphene material.

After extensive experimenting, we have discovered that practically any chemical blowing agent (e.g. in a powder or pellet form) can be used to create pores or bubbles in a dried layer of graphene when the first heat treatment temperature is sufficient to activate the blowing reaction. The chemical blowing agent (powder or pellets) may be dispersed in the liquid medium to become a second dispersed phase (sheets of graphene material being the first dispersed phase) in the suspension, which can be deposited onto the solid supporting substrate to form a wet layer. This wet layer of graphene material may then be dried and heat treated to activate the chemical blowing agent. After a chemical blowing agent is activated and bubbles are generated, the resulting foamed graphene structure is largely maintained even when subsequently a higher heat treatment temperature is applied to the structure. This is quite unexpected, indeed.

Chemical foaming agents (CFAs) can be organic or inorganic compounds that release gasses upon thermal decomposition. CF As are typically used to obtain medium-to high-density foams, and are often used in conjunction with physical blowing agents to obtain low-density foams. CFAs can be categorized as either endothermic or exothermic, which refers to the type of decomposition they undergo. Endothermic types absorb energy and typically release carbon dioxide and moisture upon decomposition, while the exothermic types release energy and usually generate nitrogen when decomposed. The overall gas yield and pressure of gas released by exothermic foaming agents is often higher than that of endothermic types. Endothermic CFAs are generally known to decompose in the range of 130 to 230° C. (266-446° F.), while some of the more common exothermic foaming agents decompose around 200° C. (392° F.). However, the decomposition range of most exothermic CFAs can be reduced by addition of certain compounds. The activation (decomposition) temperatures of CF As fall into the range of our heat treatment temperatures. Examples of suitable chemical blowing agents include sodium bicarbonate (baking soda), hydrazine, hydrazide, azodicarbonamide (exothermic chemical blowing agents), nitroso compounds (e.g. N, N-Dinitroso pentamethylene tetramine), hydrazine derivatives (e.g. 4. 4′-Oxybis (benzenesulfonyl hydrazide) and Hydrazo dicarbonamide), and hydrogen carbonate (e.g. Sodium hydrogen carbonate). These are all commercially available in plastics industry.

In the production of foamed plastics, physical blowing agents are metered into the plastic melt during foam extrusion or injection molded foaming, or supplied to one of the precursor materials during polyurethane foaming. It has not been previously known that a physical blowing agent can be used to create pores in a graphene material, which is in a solid state (not melt). We have surprisingly observed that a physical blowing agent (e.g. CO₂ or N₂) can be injected into the stream of graphene suspension prior to being coated or cast onto the supporting substrate. This would result in a foamed structure even when the liquid medium (e.g. water and/or alcohol) is removed. The dried layer of graphene material is capable of maintaining a controlled amount of pores or bubbles during liquid removal and subsequent heat treatments.

Technically feasible blowing agents include Carbon dioxide (CO₂), Nitrogen (N₂), Isobutane (C₄H₁₀), Cyclopentane (C₃H₁₀), Isopentane (C₅H₁₂), CFC-11 (CFCl₃), HCFC-22 (CHF₂Cl), HCFC-142b (CF₂CICH₃), and HCFC-134a (CH₂FCF₃). However, in selecting blowing agent, environmental safety is a major factor to consider. The Montreal Protocol and its influence on consequential agreements pose a great challenge for the producers of foam. Despite the effective properties and easy handling of the formerly applied chlorofluorocarbons, there was a worldwide agreement to ban these because of their ozone depletion potential (ODP). Partially halogenated chlorofluorocarbons are also not environmentally safe and therefore already forbidden in many countries. The alternatives are hydrocarbons, such as isobutane and pentane, and the gases such as CO₂ and nitrogen.

Except for those regulated substances, all the blowing agents recited above have been tested in our experiments. For both physical blowing agents and chemical blowing agents, the blowing agent amount introduced into the suspension is defined as a blowing agent-to-graphene material weight ratio, which is typically from 0/1.0 to 1.0/1.0.

### EXAMPLE 2

### Preparation of Discrete Graphene Sheets (GO) and Graphene Foam Particles

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution including alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%˜31% by weight. The resulting suspension contains GO sheets being suspended in water. The suspension was spray-dried to form secondary graphene particles.

For making a powder mass of graphene foam particles, the sample of secondary graphene particles was subjected to heat treatments that involved an initial thermal reduction temperature of 80-350° C. for 1-8 hours, followed by heat-treating at a second temperature of 1,500-2,850° C. for 0.5 to 5 hours. It may be noted that we have found it essential to apply a compressive stress to the sample of secondary graphene particles while being subjected to the first heat treatment. This compress stress seems to have helped maintain good contacts between the graphene sheets so that chemical merging and linking between graphene sheets can occur while pores are being formed. Without such a compressive stress, the heat-treated film was typically excessively porous with constituent graphene sheets in the pore walls being very poorly oriented and incapable of chemical merging and linking with one another. As a result, the thermal conductivity, electrical conductivity, and mechanical strength of the graphene foam were severely compromised.

### EXAMPLE 3

### Preparation of Single-Layer Graphene Sheets (and Graphene Foam Particles) From Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. Baking soda (5-20% by weight), as a chemical blowing agent, was added to a sample of the suspension just prior to spray-drying. Another sample was sprayed without baking soda to form secondary graphene particles.

The several powder samples of secondary graphene particles, with or without a blowing agent, were then subjected to heat treatments that involve an initial (first) thermal reduction temperature of 80-500° C. for 1-5 hours. This first heat treatment generated samples of powder mass of graphene foam particles. For some sample, the graphene domains in the foam wall were further perfected (re-graphitized to become more ordered or having a higher degree of crystallinity and larger lateral dimensions of graphene planes) by further heat-treating at a second temperature of 1,500-2,850° C.

### EXAMPLE 4

### Preparation of Pristine Graphene Foam (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene foam having a higher thermal conductivity. Pristine graphene sheets were produced by using the direct ultrasonication (or liquid-phase exfoliation) production process.

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

Various amounts (1%-30% by weight relative to graphene material) of chemical bowing agents (N, N-Dinitroso pentamethylene tetramine or 4. 4′-Oxybis (benzenesulfonyl hydrazide) were added to a water/graphene suspension containing pristine graphene sheets and a water soluble polymer, polyvinyl alcohol (PVA). The resulting thick slurry was then electro-spun to form PVA-graphene composite nano-fibers (275 nm in diameter). Similar nano-fibers, but without a blowing agent, were prepared for comparison.

The PVA-graphene nano-fibers were then subjected to heat treatments that involve an initial (first) temperature of 350° C. for 1-5 hours. This first heat treatment generated fibrous solid samples of graphene foam particles. Some samples of the pristine graphene foam particles were then subjected to a second temperature of 1,500-2,850° C. to determine if the graphene domains in the foam wall could be further perfected (re-graphitized to become more ordered or having a higher degree of crystallinity). Porous graphene fibers were then milled to become elongated graphene foam particles each containing graphene sheets bonded by carbon.

### EXAMPLE 5

### Preparation of Graphene Oxide (GO) Suspension From Natural Graphite and of Subsequent GO Foam Particles

Graphite oxide was prepared by oxidation of graphite flakes with an oxidizer liquid including sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 72 hours, the reacting mass was rinsed with water 3 times to adjust the pH value to at least 3.0. A final amount of water was then added to prepare a series of GO-water suspensions. We observed that GO sheets (having an oxygen content of approximately 54% by weight) form a liquid crystal phase when GO sheets occupy a weight fraction >3% and typically from 5% to 15%.

By dispensing and coating the GO suspension on a polyethylene terephthalate (PET) film in a slurry coater and removing the liquid medium from the coated film we obtained a thin film of dried graphene oxide. Several GO film samples were then subjected to different heat treatments, which typically include a thermal reduction treatment at a first temperature of 100° C. to 500° C. for 1-10 hours, and at a second temperature of 1,500° C.-2,850° C. for 0.5-5 hours. With these heat treatments, also under a compressive stress, the GO films were transformed into graphene foam. Sheets of graphene foam were then cut into sizes smaller than 5 mm and subjected to milling to reduce the pieces of graphene foam into graphene foam particles of typically 85-176 μm in width or length and 27-45 μm in thickness.

### EXAMPLE 6

### Graphene Foam Particles From Hydrothermally Reduced Graphene Oxide

For comparison, a self-assembled graphene hydrogel (SGH) sample was prepared by a hydrothermal method. The SGH was prepared by heating 2 mg/mL of homogeneous graphene oxide (GO) aqueous dispersion sealed in a Teflon-lined autoclave at 180° C. for 12 h. The SGH containing about 2.6% (by weight) graphene sheets and 97.4% water has an electrical conductivity of approximately 5×10⁻³ S/cm. Upon drying and heat treating at 1,500° C., the resulting graphene foam exhibits an electrical conductivity of approximately 1.5×10⁻¹ S/cm, which is 2 times lower than those of the graphene foam sheets produced by heat treating at the same temperature (Example 5). The dried graphene foam samples were then heat-treated at 2,500° C. for 2 hours and air jet-milled to form graphene foam particles having a dimension from 5.7 to 114μ.

### EXAMPLE 7

### Preparation of Graphene Foam Particles From Graphene Fluoride

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication times ensured better stability.

Upon casting on a glass surface with the solvent removed, the dispersion became a brownish film formed on the glass surface. When GF films were heat-treated, fluorine was released as gases that helped to generate pores in the film. In some samples, a physical blowing agent (N₂ gas) was injected into the wet GF film while being cast. These samples exhibit much higher pore volumes or lower foam densities. Without using a blowing agent, the resulting graphene fluoride foams exhibit physical densities from 0.35 to 1.38g/cm³. When a blowing agent was used (blowing agent/GF weight ratio from 0.5/1 to 0.05/1), a density from 0.02 to 0.35 g/cm³ was obtained. Typical fluorine contents are from 0.001% (HTT=2,500° C.) to 4.7% (HTT=350° C.), depending upon the final heat treatment temperature involved. It was observed that that the GF foams, in comparison with GO foams, exhibit higher thermal conductivity values at comparable specific gravity values. Both deliver impressive heat-conducting capabilities, being the best among all known foamed materials.

The GF films were then cut into smaller pieces less than 2 cm in length or width and ball-milled to further reduce sizes and re-shape the particles into spheroidal shape (elongated length dimension of approximately 17-47 μm and lateral dimension 14-23 μm).

### EXAMPLE 8

### Preparation of Graphene Foam Particles From Nitrogenataed Graphene

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene: urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis. These nitrogenataed graphene sheets remain dispersible in water. The resulting suspensions were then spray-dried and heat-treated initially at 200-350° C. as a first heat treatment temperature and subsequently treated at a second temperature of 1,500°C. The resulting nitrogenated graphene foam particles exhibit physical densities from 0.45 to 1.28g/cm³. Typical nitrogen contents of the foam particles are from 0.01% (HTT=1,500° C.) to 5.3% (HTT=350° C.), depending upon the final heat treatment temperature involved.

### EXAMPLE 9

### Characterization of Various Powders of Graphene Foam Particles

The internal structures (crystal structure and orientation) of several dried GO particles or in a layer form, and the heat-treated particles and films at different stages of heat treatments were investigated using X-ray diffraction. The X-ray diffraction curve of natural graphite typically exhibits a peak at approximately 2θ=26°, corresponds to an inter-graphene spacing (d₀₀₂) of approximately 0.3345 nm. Upon oxidation, the resulting GO shows an X-ray diffraction peak at approximately 2θ=12°, which corresponds to an inter-graphene spacing (d₀₀₂) of approximately 0.7 nm. With some heat treatment at 150° C., the dried GO compact exhibits the formation of a hump centered at 22°, indicating that it has begun the process of decreasing the inter-graphene spacing due to the beginning of chemical linking and ordering processes. With a heat treatment temperature of 2,500° C. for one hour, the door spacing has decreased to approximately 0.336, close to 0.3354 nm of a graphite single crystal.

With a heat treatment temperature of 2,750° C. for one hour, the door spacing is decreased to approximately to 0.3354 nm, identical to that of a graphite single crystal. In addition, a second diffraction peak with a high intensity appears at 2θ=55° corresponding to X-ray diffraction from (004) plane. The (004) peak intensity relative to the (002) intensity on the same diffraction curve, or the I(004)/I(002) ratio, is a good indication of the degree of crystal perfection and preferred orientation of graphene planes. The (004) peak is either non-existing or relatively weak, with the I(004)/I(002) ratio <0.1, for all graphitic materials heat treated at a temperature lower than 2,800° C. The I(004)/I(002) ratio for the graphitic materials heat treated at 3,000-3,250° C. (e,g, highly oriented pyrolytic graphite, HOPG) is in the range of 0.2-0.5. In contrast, a graphene foam prepared with a final HTT of 2,750° C. for one hour exhibits a I(004)/I(002) ratio of 0.78 and a Mosaic spread value of 0.21, indicating a practically perfect graphene single crystal with a good degree of preferred orientation.

The “mosaic spread” value is obtained from the full width at half maximum of the (002) reflection in an X-ray diffraction intensity curve. This index for the degree of ordering characterizes the graphite or graphene crystal size (or grain size), amounts of grain boundaries and other defects, and the degree of preferred grain orientation. A nearly perfect single crystal of graphite is characterized by having a mosaic spread value of 0.2-0.4. Some of our graphene foams have a mosaic spread value in this range of 0.2-0.4 when produced using a final heat treatment temperature no less than 2,500° C..

The inter-graphene spacing values of both the GO suspension-derived samples obtained by heat treating at various temperatures over a wide temperature range are summarized in FIG. 8A. Corresponding oxygen content values in the GO suspension-derived unitary graphene layer are shown in FIG. 8B.

It is of significance to point out that a heat treatment temperature as low as 500° C. is sufficient to bring the average inter-graphene spacing in GO sheets along the pore walls to below 0.4 nm, getting closer and closer to that of natural graphite or that of a graphite single crystal.

The beauty of this approach is the notion that this GO suspension strategy has enabled us to re-organize, re-orient, and chemically merge the planar graphene oxide molecules from originally different graphite particles or graphene sheets into a unified structure with all the graphene planes now being larger in lateral dimensions (significantly larger than the length and width of the graphene planes in the original graphite particles). A potential chemical linking mechanism is illustrated in FIG. 3. This has given rise to exceptional thermal conductivity and electrical conductivity values.

In conclusion, we have successfully developed a new, novel, and patently distinct class of highly conducting graphene foam particles, devices containing these particles as a functional element or member, and related processes of production. The chemical composition (% of oxygen, fluorine, and other non-carbon elements), structure (crystal perfection, grain size, defect population, etc), crystal orientation, morphology, process of production, and properties of this new class of foam materials are fundamentally different and patently distinct from meso-phase pitch-derived graphite foam, CVD graphene-derived foam, and graphene foams from hydrothermal reduction of GO, and sacrificial bead template-assisted RGO foam. The thermal conductivity, electrical conductivity, elastic modulus, and flexural strength exhibited by the presently invented foam materials are much higher than what prior art foam materials. Most significantly, the graphene foam.

1. A solid mass of multiple individual graphene foam particles wherein at least a particle has a particle size from 10 nm to 10 cm and comprises multiple pores and multiple graphene sheets that are self-bonded or bonded by a binder to form pore walls, and wherein the graphene sheets contain a pristine graphene material, having essentially zero % (less than 0.01% by weight) of non-carbon elements, or a non-pristine graphene material having 0.01% to 57% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, chemically functionalized graphene, or a combination thereof.

2. The solid mass of multiple graphene foam particles of claim 1, wherein said solid graphene foam particle has a density from 0.001 to 1.7 g/cm³ and a specific surface area from 50 to 3,000m²/g, and the pores have an average pore size in a range from 1 nm to 1 mm.

3. The solid mass of multiple graphene foam particles of claim 1, wherein said pore walls contain stacked graphene planes having an inter-plane spacing d₀₀₂ from 0.3354 nm to 2.0 nm as measured by X-ray diffraction.

4. The solid mass of multiple graphene foam particles of claim 1, wherein said pore walls contain a pristine graphene and said solid graphene foam has a density from 0.5 to 1.7 g/cm³ or an average pore size from 1 nm to 50 nm.

5. The solid mass of multiple graphene foam particles of claim 1, wherein said graphene oxide has an oxygen content greater than 25% by weight.

6. The solid mass of multiple graphene foam particles of claim 1, wherein said pore walls contain a non-pristine graphene material selected from the group consisting of graphene oxide, reduced graphene oxide, graphene fluoride, graphene chloride, graphene bromide, graphene iodide, hydrogenated graphene, nitrogenated graphene, chemically functionalized graphene, and combinations thereof, and wherein said solid graphene foam particle contains a content of non-carbon elements in the range of 0.01% to 25% by weight.

7. The solid mass of multiple graphene foam particles of claim 1, wherein said pore walls contain graphene fluoride and said solid graphene foam particle contains a fluorine content from 0.01% to 25% by weight.

8. The solid mass of multiple graphene foam particles of claim 1, wherein said pore walls contain chemically functionalized graphene comprising a functional group selected from hydroxyl, peroxide, ether, ester, ketone, aldehyde, halide, alcohol, thiol, ether, sulfide, carbonyl, carboxylic, alkene, alkyne, amine, quinone, epoxy, phenolic, amino, or a combination thereof.

9. The solid mass of multiple graphene foam particles of claim 1, wherein said pore walls contain chemically functionalized graphene that contains a functional group selected from the group consisting of SO₃H, COOH, NH₂, NH₃, NH₄, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

10. The solid mass of multiple graphene foam particles of claim 1, wherein said pore walls contain chemically functionalized graphene containing a functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof.

11. The solid mass of multiple graphene foam particles of claim 1, wherein said pore walls contain chemically functionalized graphene containing a functional group selected from OY, NHY, O═C—OY, P═C—NR′Y, O═C—SY, O═C—Y, —CR′l—OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

12. The solid mass of multiple graphene foam particles of claim 1, wherein said solid graphene foam has a specific surface area from 200 to 2,000m²/g or a density from 0.1 to 1.5 g/cm³.

13. The solid mass of multiple graphene foam particles of claim 1, wherein said non-carbon elements include an element selected from oxygen, fluorine, chlorine, bromine, iodine, nitrogen, hydrogen, or boron.

14. The solid mass of multiple graphene foam particles of claim 1, wherein said particles have an average size from 20 nm to 2 mm, preferably from 50 nm to 0.5 mm.

15. The solid mass of multiple graphene foam particles of claim 1, wherein said graphene foam particles are in a form selected from spherical particle, ellipsoidal particle, elongated particle, fiber, disc, plate, tube, rod, or odd shape.

16. The solid mass of multiple graphene foam particles of claim 1, wherein said graphene foam particle has an oxygen content or non-carbon content less than 10% by weight, and said pore walls have an inter-graphene spacing less than 0.4 nm.

17. The solid mass of multiple graphene foam particles of claim 1, wherein said graphene foam particle has an oxygen content or non-carbon content less than 1% by weight, and said pore walls have an inter-graphene spacing less than 0.36 nm.

18. The solid mass of multiple graphene foam particles of claim 1, wherein said pore walls contain a 3D network of interconnected graphene planes.

19. The solid mass of multiple graphene foam particles of claim 1, wherein said solid graphene foam particle contains meso-scaled pores having a pore size from 2 nm to 50 nm.

20. The solid mass of multiple graphene foam particles of claim 1, wherein said graphene foam particle further comprises a binder material that bonds multiple graphene sheets together.

21. The solid mass of multiple graphene foam particles of claim 20, wherein said binder material is selected from a polymer, metal, glass, ceramic, carbon (e.g., amorphous carbon, polymeric carbon or carbon derived from a polymer), or a combination thereof.

22.-51. (canceled)
